(19) United States
(12) Patent Application Publication
(10) Pub. No.: US 2023/0277398 A1
(43) Pub. Date: Sep. 7, 2023

(54) SUPPORT STRUCTURE AND METHOD FOR AT LEAST PARTIALLY ELEVATING A PERSON VIA A HOIST

(71) Applicant: Melior Motus Inc., Halifax (CA)

(72) Inventors: Stephen Douglas BEED, Halifax (CA); Paul LAPSTUN, Sydney (AU); Vincent Cyprien CASTONGUAY-SIU, Calgary (CA)

(21) Appl. No.: 18/179,185

(22) Filed: Mar. 6, 2023

Related U.S. Application Data
(60) Provisional application No. 63/316,744, filed on Mar. 4, 2022.
(60) Provisional application No. 63/319,149, filed on Mar. 11, 2022.

(51) Int. Cl. A61G 7/10

(52) U.S. Cl. CPC A61G 7/1015; A61G 7/1055

(57) ABSTRACT

A support structure and method for at least partially elevating a person via a hoist are provided. The support structure is connectable to or forms part of a retention structure secured around a person. At least two connectors are configured for connecting to the hoist, the at least two connectors being located or locatable to enable selection of a first set of positions or a second set of positions at which the hoist is connectable to the support structure. Each of the first set of positions and the second set of positions extend along a span of a longitudinal axis of the retention structure. The span of the second set of positions differs from the span of the first set of positions.

### CROSS-REFERENCE TO RELATED APPLICATIONS

This application claims the benefit of U.S. Provisional Patent Application No. 63/316,744, filed Mar. 4, 2022, and U.S. Provisional Patent Application No. 63/319,149, filed Mar. 11, 2022, the contents of both of which are incorporated herein by reference in their entirety.

### FIELD

The specification relates generally to medical equipment. In a particular example, the specification relates to a support structure and method for at least partially elevating a person via a hoist.

### SUMMARY OF THE DISCLOSURE

In one aspect, there is provided a support structure for lifting a person, such as with a hoist, comprising: a bar portion; a hoist connector extending from the bar portion and configured for connection to a hoist; and a set of cable spools coupled to the bar portion, each of the cable spools being independently operable to vary a length of a cable extending therefrom, the cable being lockable to inhibit further extension of the cable from the cable spool, the cable having a load connector towards a distal end thereof for securing the cable to a retention structure retaining a person.

The cable spools can be spring-biased. In one particular aspect, the cable spools can be spring biased towards a neutral angular position at which the cables are at least partially retracted.

The cable can be guided by guide rollers through an aperture.

Each cable spool can be positioned in a housing of the support structure.

A locking structure can restrict further extension of the cables. The locking structure can be a spool rotation lock restricting rotation of one or more of the cable spools. The spool rotation lock can include a ratchet and pawl mechanism. The locking structure can be a clamping structure configured to clamp one or more of the cables. The clamping structure can include a cam-shaped member that, when rotated, clamps one or more of the cables.

A single control can lock extension of two or more cables simultaneously.

In another aspect, there is provided a support structure for lifting person, the support structure having a hoist connector configured for connection to a hoist, and a set of connector features for securing connectors to connect to a retention structure for retaining a person, the support structure being reconfigurable between a compact state, and an extended state in which at least two of the set of connector features are further apart than in the compact state.

The hoist connector can include a first support structure portion, and the set of connector features can be provided on a second support structure portion moveably connected to the first support structure portion.

The first and second support structure portions can each have a longitudinal axis. In the compact state, the longitudinal axis of the first support structure portion can be generally parallel to the longitudinal axis of the second support structure portion. In the extended state, the longitudinal axis of the first support structure can be generally non-parallel to the longitudinal axis of the second support structure portion.

In some embodiments, the longitudinal axis of the first support structure portion can be generally perpendicular to the longitudinal axis of the second support structure portion.

The second support structure portion can be pivotally connected to the first support structure portion.

A set of cable spools can be coupled to the second support structure portion, each of the cable spools being independently operable to vary a length of a cable extending therefrom, the cable being lockable to inhibit further extension of the cable from the cable spool, the cable having a load connector towards a distal end thereof for securing the cable to a retention structure retaining a person.

A third support structure portion can be moveably connected to the first support structure portion. The third support structure portion can be pivotally connected to the first support structure portion.

A set of cable spools can be coupled to the third support structure portion, each of the cable spools being independently operable to vary a length of a cable extending therefrom, the cable being lockable to inhibit further extension of the cable from the cable spool, the cable having a load connector towards a distal end thereof for securing the cable to a retention structure retaining a person.

The hoist connector can include at least one aperture.

The set of connector features on the second support structure portion can include at least one aperture.

The support structure can include a securement structure for securing the second support structure portion relative to the first support structure portion alternatively in the compact state and the extended state.

The set of connector features can include a set of cable spools, each of the set of cable spools being independently operable to vary a length of a cable extending therefrom, the cable being lockable to inhibit further extension of the cable from the cable spool, the cable having a load connector towards a distal end thereof for securing the cable to the retention structure.

In a further aspect, there is provided a support structure for lifting a person, such as with a hoist, comprising a levelling structure for adjusting a location at which a hoist connects to the support structure.

The levelling structure can include two or more positions at which the hoist connects to the support structure.

The levelling structure can include at least two hoist connector features that the hoist can be selectively connected to. The at least two hoist connector features can extend along a longitudinal axis of the support structure.

The levelling structure can include notches along a generally downwardly facing surface of the support structure. The downwardly facing surface can be provided on a hoist connector bar extending from a main body of the support structure.

The support structure can include a restriction structure for restricting separation of a hoist connector from the support structure.

Where the levelling structure includes notches along a generally downwardly facing surface of a hoist connector bar extending from a main body of the support structure, the restriction structure can include an enlarged section of the bar. The enlarged section can exceed a loop size of the hoist connectors.

The restriction structure can be a releasably securable gate inhibiting separation of the hoist connector from the support structure.

In another aspect, the present invention provides an apparatus for lifting a person using a hoist, the apparatus comprising at least one support bar closely coupled to a wrap cocooning the person, and at least two adjustable hoist connection straps coupled to the hoist.

In another aspect, the present invention provides an apparatus for lifting a person using a hoist, the apparatus comprising a plurality of adjustable hoist connection straps coupled to a wrap cocooning the person, and to a T-bar of the hoist.

The wrap may comprise one or more stiffeners to impart rigidity to the cocooned person.

The stiffener may be hinged.

Each hoist connection strap may have an auto-retracting spool.

In another aspect, the present invention provides a method for leveling a load attached to a hoist at a lifting point, the method comprising positioning the lifting point above a center of mass of the load.

The load may be a person, and the person may be cocooned in a wrap.

In another aspect, the present invention provides a method for leveling a load attached to a hoist via a support element bar, the method comprising positioning a lifting point of the hoist above a center of mass of the load, and aligning the support element bar proportionally to the center of mass of the load.

In another aspect, the present invention provides a support bar for leveling a load attached to a hoist via the support bar, the support bar comprising a plurality of hoist connection apertures.

In another aspect, the present invention provides a support bar for leveling a load attached to a hoist via the support bar, the support bar comprising a movable hoist connection bar, the connection bar comprising at least two hoist connection apertures.

The movable hoist connection bar may be lockable at a position.

In another aspect, the present invention provides a support bar for leveling a load attached to a hoist via the support bar, the support bar comprising a hoist connection cable and a pair of pulleys supporting the hoist connection cable, one pulley coupled to a handle to allow the cable to be moved, thus altering the relative lengths of the two ends of the cable outside of the support bar.

In another aspect, the present invention provides a support bar for leveling a load attached to a hoist via the support bar, the support bar comprising a hoist connection cable and a pair of pulleys supporting the hoist connection cable, a block fixed to the cable coupled to a handle to allow the cable to be moved, thus altering the relative lengths of the two ends of the cable outside of the support bar.

In another aspect, the present invention provides a support bar for leveling a load attached to a hoist via the support bar, the support bar comprising a hoist connection cable and a pair of pulleys supporting the hoist connection cable, one pulley coupled to a motor to allow the cable to be moved, thus altering the relative lengths of the two ends of the cable outside of the support bar.

In another aspect, the present invention provides a support bar for leveling a load attached to a hoist via the support bar, the support bar comprising a hoist connection cable and a pair of pulleys supporting the hoist connection cable, a block fixed to the cable coupled to a motor to allow the cable to be moved, thus altering the relative lengths of the two ends of the cable outside of the support bar.

In another aspect, the present invention provides a leveling apparatus for leveling a load attached to a hoist via the leveling apparatus, the leveling apparatus comprising a load support cable attachable at both ends to the load, and a drive pulley supporting the load support cable, the pulley coupled to a motor to allow the cable to be moved, thus altering the relative lengths of the two ends of the cable outside of the leveling apparatus.

The motor according to any of the previous aspects may be controlled by a controller. The controller may be responsive to a level signal from a level sensor. The controller may be remotely controllable via a wired or wireless connection.

In another aspect, the present invention provides an apparatus for leveling a load attached to a motorized hoist via a leveling apparatus, the apparatus comprising the hoist and the leveling apparatus, the leveling apparatus comprising any motorized support bar or leveling apparatus according to a previous aspect, the apparatus configured to position a lifting point of the hoist above a center of mass of the load, and to control the leveling apparatus to level the load.

The apparatus may be configured to be responsive to a level signal to automatically level the load, or the apparatus may be configured to be responsive to a set of operator commands to level the load.

In a further aspect of the present disclosure, there is provided a support structure for at least partially elevating a person via a hoist, the support structure being connectable to or forming part of a retention structure secured around a person, comprising: at least two connectors configured for connecting to the hoist, the at least two connectors being located or locatable to enable selection of a first set of positions or a second set of positions at which the hoist is connectable to the support structure, each of the first set of positions and the second set of positions extending along a span of a longitudinal axis of the retention structure, the span of the second set of positions differing from the span of the first set of positions.

In some or all examples of the further aspect, the retention structure is a wrap.

In some or all examples of the further aspect, the support structure forms part of retention structure.

In some or all examples of the further aspect, each of the at least two connectors is an aperture.

In some or all examples of the further aspect, the support structure includes a support member to which the retention structure is connectable.

In some or all examples of the further aspect, each of the at least two connectors is a notch along a surface of the support member that at least partially faces downwards when the support structure is connected to the retention structure and the hoist.

In some or all examples of the further aspect, the at least two connectors are apertures.

In some or all examples of the further aspect, one or more of the at least two connectors is located on at least one connector support member that is secured to the support member and movable relative to the support member.

In some or all examples of the further aspect, the at least one connector support member slidingly engages the support member

In some or all examples of the further aspect, the at least one connector support member is fixable at discrete locations relative to the support member.

In some or all examples of the further aspect, the at least two connectors comprises at least three connectors, wherein the at least three connectors are located at fixed locations along the support structure, and wherein each set of the first set of positions and the second set of positions corresponds to a subset of the at least three connectors.

In a still further aspect of the present disclosure, there is provided a method of at least partially elevating a person via a hoist, comprising: connecting a support structure to a retention structure secured around a person, the support structure including a support member to which the retention structure is connectable, the support structure including at least two connectors configured for connecting to the hoist, the at least two connectors being located or locatable to enable selection of a first set of positions or a second set of positions at which the hoist is connectable to the support structure, each of the first set of positions and the second set of positions extending along a span of a longitudinal axis of the retention structure, the span of the second set of positions differing from the span of the first set of positions; connecting the hoist to at least a subset of the at least two connectors of the support structure; and operating the hoist to elevate the support structure and at least partially elevate the retention structure secured around the person.

In some or all examples of the still further aspect, each of the at least two connectors is a notch along a surface of the support member that at least partially faces downwards when the support structure is connected to the retention structure and the hoist.

In some or all examples of the still further aspect, the at least two connectors are apertures.

In some or all examples of the still further aspect, one or more of the at least two connectors is located on at least one connector support member that is secured to the support member and movable relative to the support member, the method further comprising moving the connector support member relative to the support member to select the first set of positions or the second set of positions.

In some or all examples of the still further aspect, the at least one connector support member slidingly engages the support member.

In some or all examples of the still further aspect, the at least one connector support member is fixable at discrete locations relative to the support member.

In some or all examples of the still further aspect, the at least two connectors comprises at least three connectors, wherein the at least three connectors are located at fixed locations along the support structure, wherein the first set of positions corresponds to a first subset of the at least three connectors, and wherein the second set of positions corresponds to a second subset of the at least three connectors, the method further comprising connecting the hoist to one of the first subset of the at least three connectors and the second subset of the at least three connectors.

In some or all examples of the still further aspect, each of the at least three connectors is an aperture.

In some or all examples of the still further aspect, the support structure forms part of retention structure.

Other technical advantages may become readily apparent to one of ordinary skill in the art after review of the following figures and description.

### BRIEF DESCRIPTIONS OF THE DRAWINGS

For a better understanding of the embodiment(s) described herein and to show more clearly how the embodiment(s) may be carried into effect, reference will now be made, by way of example only, to the accompanying drawings in which:

FIG. 1 shows a support bar in accordance with an embodiment;

FIG. 2A shows some of the internal components within the support bar of FIG. 1;

FIG. 2B is a rear elevation view of a bar portion of the support bar of FIG. 1;

FIG. 2C is a left side elevation view of the bar portion of the support bar of FIG. 1;

FIG. 2D is a front elevation view of the internal components of FIG. 2A in isolation;

FIG. 2E is a left side elevation view of the internal components of FIG. 2D;

FIG. 3 shows the support bar of FIGS. 1 to 2E supporting a person cocooned in a wrap and being lifted by a hoist;

FIG. 4 shows a support bar in accordance with another embodiment;

FIG. 5A shows a locking mechanism of the support bar of FIG. 4 for clamping a cable in an unlocked position;

FIG. 5B shows the locking mechanism of FIG. 5A in a locked position;

FIG. 6A shows a support bar in accordance with a further embodiment;

FIG. 6B shows a spool module of the support bar of FIG. 6A in greater detail;

FIG. 7A is an isometric view of a support bar in accordance with another embodiment in a closed state;

FIG. 7B is a top view of the support bar of FIG. 7A;

FIG. 7C is a front elevation view of the support bar of FIGS. 7A and 7B;

FIG. 7D is a rear elevation view of the support bar of FIGS. 7A to 7C;

FIG. 8A is a front elevation view of the support bar of FIGS. 6A to 6D in an open state;

FIG. 8B is a top plan view of the support bar of FIG. 8A;

FIG. 8C is an isometric view top view of the support bar of FIGS. 8A and 8B;

FIG. 9A is an isometric view of a support bar in accordance with another embodiment in a closed state;

FIG. 9B is a front elevation view of the support bar of FIG. 9A;

FIG. 9C is a bottom view of the support bar of FIGS. 9A to 9B;

FIG. 10A is an isometric view of the support bar of FIGS. 9A to 9C in an open state;

FIG. 10B is a front elevation view of the support bar of FIG. 10A;

FIG. 10C is a bottom view of the support bar of FIGS. 10A and 10B;

FIG. 11A is an isometric view of a support bar in accordance with another embodiment in a closed state;

FIG. 11B is a front elevation view of the support bar of FIG. 11A;

FIG. 11C is a top view of the support bar of FIGS. 11A and 11B;

FIG. 12A is an isometric view of the support bar of FIGS. 11A to 11C in an open state;

FIG. 12B is a front elevation view of the support bar of FIG. 12A;

FIG. 12C is a top view of the support bar of FIGS. 12A and 12B;

FIG. 12D is a left side elevation view of the support bar of FIGS. 12A to 12C;

FIG. 13A is a side elevation view of a support structure in accordance with yet another embodiment;

FIG. 13B is a bottom view of the support structure of FIG. 13A;

FIG. 14 is a side elevation view of a support bar configuration in accordance with another embodiment supporting a person cocooned in a wrap and being lifted by a hoist;

FIG. 15 is a side elevation view of a support bar configuration in accordance with another embodiment, with the support bar closely coupled to a wrap;

FIG. 16 is a side elevation view of a support bar configuration in accordance with another embodiment, with a pair of support bars closely coupled to a wrap;

FIG. 17 is a side elevation view of a support strap configuration in accordance with another embodiment, with straps coupled directly to a wrap;

FIG. 18 is a side elevation view of a support strap configuration in accordance with another embodiment, with straps coupled directly to a wrap containing a stiffener;

FIG. 19A is a side elevation view of the stiffener of FIG. 18;

FIG. 19B is a side elevation view of a stiffener in accordance with another embodiment;

FIG. 19C is a side elevation view of the stiffener of FIG. 19B in a partially folded state;

FIG. 19D is a side elevation view of the stiffener of FIG. 19B in a fully folded state;

FIG. 20 is a side elevation view of a support strap configuration in accordance with another embodiment, with straps coupled directly to a wrap containing a pair of stiffeners;

FIG. 21 is a side elevation view of a support strap configuration in accordance with another embodiment, with spooled straps coupled directly to a wrap;

FIG. 22A is a side elevation view of a load leveling configuration in accordance with another embodiment, with the load lifted directly via a lifting point;

FIG. 22B is a side elevation view of a load leveling configuration in accordance with another embodiment, with the load lifted via an intermediate support element;

FIG. 23A is a side elevation view of a support bar in accordance with another embodiment with multiple hoist connection apertures, connected to support a load with a central center of mass;

FIG. 23B is a side elevation view of the support bar of FIG. 23A, connected to support a load with a left-of-center center of mass;

FIG. 23C is a side elevation view of the support bar of FIG. 23A, connected to support a load with a right-of-center center of mass;

FIG. 24A is a side elevation view of a support bar in accordance with another embodiment, with support for a movable host connection bar;

FIG. 24B is an end elevation view of the support bar of FIG. 24A;

FIG. 24C is a side elevation view of the support bar of FIG. 24A with a host connection bar configured to support a load with a left-of-center center of mass;

FIG. 24D is an end elevation view of the support bar of FIG. 24C;

FIG. 24E is a side elevation view of the support bar of FIG. 24C with the host connection bar configured to support a load with a central center of mass;

FIG. 24F is a side elevation view of the support bar of FIG. 24C with the host connection bar configured to support a load with a right-of-center center of mass;

FIG. 25A is a side elevation view of a leveling mechanism in accordance with another embodiment, with a windable continuous support cable attached to a hoist T-bar;

FIG. 25B is a side elevation view of the leveling mechanism of FIG. 25A, configured to support a load with a left-of-center center of mass;

FIG. 26A is a side elevation view of a leveling mechanism of FIG. 25A attached to a hoist hook;

FIG. 26B is a side elevation view of the leveling mechanism of FIG. 26A, configured to support a load with a left-of-center center of mass;

FIG. 27A is a side elevation view of a leveling mechanism in accordance with another embodiment, with a motorized continuous support cable attached to a hoist hook;

FIG. 27B is a side elevation view of the leveling mechanism of FIG. 27A, configured to support a load with a left-of-center center of mass;

FIG. 28A is a side elevation view of a leveling mechanism in accordance with another embodiment, with a motorized continuous support cable attached to support bar or directly to a load; and

FIG. 28B is an end elevation view of the leveling mechanism of FIG. 28A.

Unless otherwise specifically noted, articles depicted in the drawings are not necessarily drawn to scale.

### DETAILED DESCRIPTION

For simplicity and clarity of illustration, where considered appropriate, reference numerals may be repeated among the Figures to indicate corresponding or analogous elements. In addition, numerous specific details are set forth in order to provide a thorough understanding of the embodiment or embodiments described herein. However, it will be understood by those of ordinary skill in the art that the embodiments described herein may be practiced without these specific details. In other instances, well-known methods, procedures and components have not been described in detail so as not to obscure the embodiments described herein. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description. It will also be noted that the use of the term “a” or “an” will be understood to denote “at least one” in all instances unless explicitly stated otherwise or unless it would be understood to be obvious that it must mean “one”.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

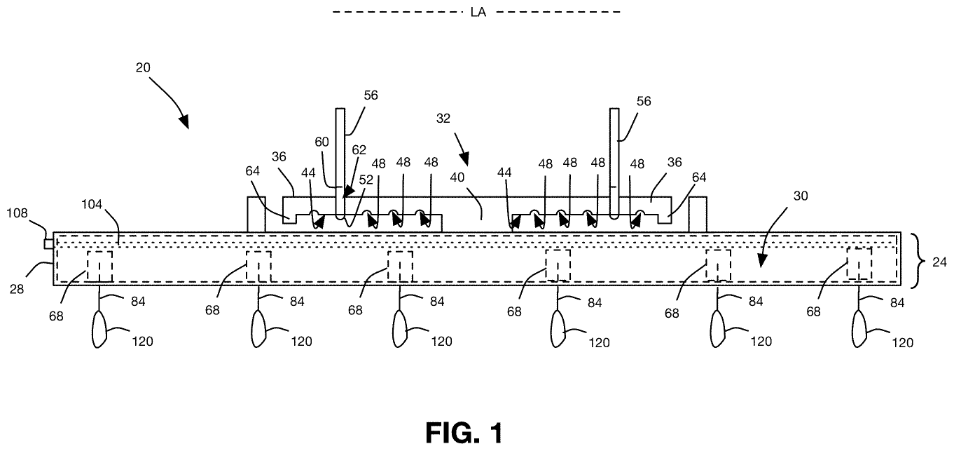

FIG. 1 shows a support structure for lifting a person in accordance with an embodiment. In this particular embodiment, the support structure is a support bar 20 for lifting a person with a hoist. The support bar 20 includes a bar portion 24 that extends along a longitudinal axis LA. The bar portion 24 includes a generally tubular housing 28 having a cavity 30 therein. The housing 28 is constructed of steel, aluminum, or any other material that is sufficiently rigid and resistant to bending forces.

A hoist connector 32 extends from the bar portion 24 and is designed to enable connection to a hoist. The hoist connector 32 is generally T shaped and has two arms 36 extending from a central post 40. In a present configuration, the hoist connector 32 is formed integrally with the housing 28 via machining or another suitable process. In other embodiments, the hoist connector can be one or more separate elements coupled to the bar portion. Each of the arms 36 has a lower surface 44 that has a set of five notches 48 that are each dimensioned to receive a metal post 52 secured to a strap loop 56. In other embodiments, the post 52 can be made of another suitable material, or the notches 48 may simply receive the strap loop 56. The strap loop 56 has stitches 60 securing the two portions together. A subloop 62 defined by the stitches 60 is sufficiently large to enable repositioning of the post 52 in another notch 48, yet sufficiently small to inhibit passage of the subloop 62 over walls 64 that extend downwardly towards the ends of the arms 36 and toward the bar portion 24. In this manner, the strap loops 56 remain secured on the hoist connector 32. The hoist connector 32 is positioned generally centrally across the width of the bar portion 24 to reduce rolling of the support bar 20 along its longitudinal axis LA.

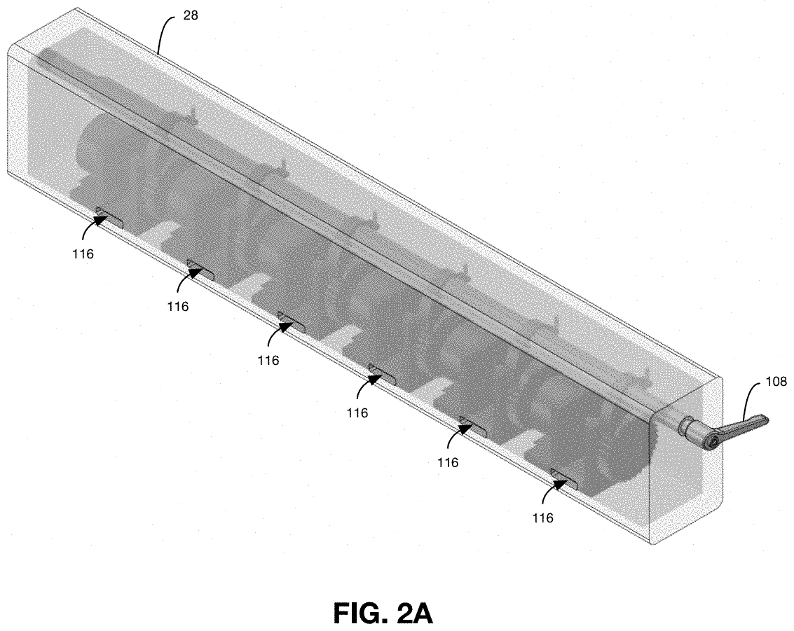

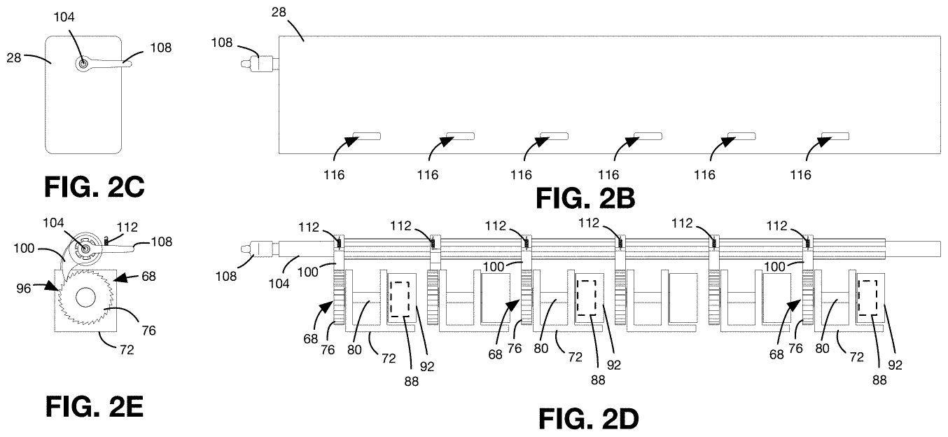

Now referring to FIGS. 1 to 2E, positioned within the bar portion 24 are a set of spools 68. In the particular configuration shown, there are six spools 68, but it is contemplated that the number of spools can be varied in other configurations. Each spool 68 is rotatably mounted on a spool support frame 72, and has a gear 76 from which a spool shaft 80 extends. A space in the spool support frame 72 in which the spool shaft 80 is positioned enables a cable 84 to be wound therearound. For the purposes of this disclosure, the term “cable” shall encompass a metal cable, a nylon cable, a fabric strap, or any other type of suitably flexible ligature for supporting a part of the weight of a person. A torsion spring 88 positioned within a spring housing 92 biases the spool 68 to rotate to a neutral angular position. The gear 76 has a toothed surface 96 that is engaged by a corresponding pawl 100 mounted on a pawl coupling bar 104. The pawl coupling bar 104 is rotatably mounted in the housing 28 and has a control lever 108 towards an end that is positioned outside of the housing 28. The pawl coupling bar 104 is biased via a set of tension springs 112 toward an engagement rotation position shown in FIGS. 2D and 2E, wherein the pawl 100 engages one of the teeth of the toothed surface 96 to inhibit rotation of the spool 68 in a rotational direction that would enable further extension of the cable 84. Actuation of the control lever 108 causes the pawl coupling bar 104 to rotate, thereby disengaging the pawl 100 from the gear 76 to allow the spool 68 to rotate to enable extension of the cable 84 from the support bar 20. The cable 84 extends through the housing 28 via a cable outlet 116. A carabineer 120 is secured at the distal end of each cable 84 for securing the cable 84 to a load.

In order to couple the carabiners 120 to a retention structure retaining a person, each carabineer 120 is independently pulled toward a corresponding connector on the retention structure. Pulling of the carabineer 120 with a force exceeding the biasing torque force exerted by the torsion spring 88 causes the spool shaft 80 to rotate to allow the cable 84 to extend from the bar portion 24.

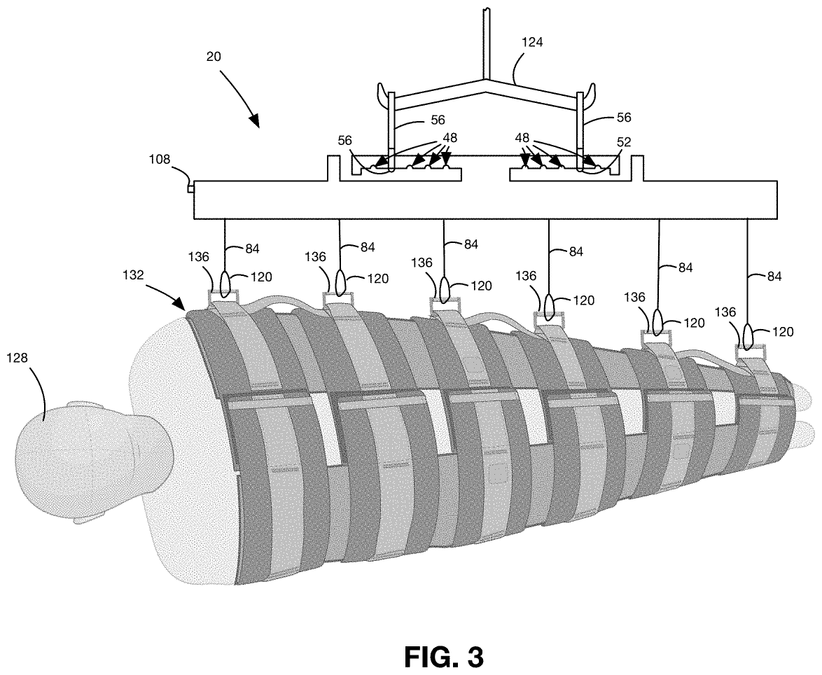

FIG. 3 shows the support bar 20 coupled to a T bar 124 of a hoist and supporting a person 128 cocooned in a wrap 132. The carabiners 120 at the ends of the cables 84 are secured to loops 136 of the wrap 132. The loops 136 are generally linearly aligned on the wrap 132. As will be understood, the dimensions of the person 128 can vary. Some persons can have large shoulders and narrow hips. Other persons can have a larger mid-section. As a result, in order to maintain the person 128 in a particular (generally horizontal) orientation, it is desirable to adjust the length of the cables 84 so that the weight of the person is distributed across all of the cables 84 and thus the support bar 20.

Further, depending on the weight distribution of the person 128, the position of the posts 52 in the set of notches 48 can be adjusted to center the weight of the person 128 relative to the support bar 20.

Once it is determined that lifting via the hoist is no longer required, the carabiners 120 can be decoupled from the loops 136. Without the load being connected to the carabiners 120, the torque force of the torsion springs 88 urges the spool shaft 80 to rotate, thereby retracting the cable 84 back into the housing of the bar portion 24. The torsion springs 88 can be configured to have a neutral angular position that retracts the cables 84 fully until the carabiners 120 contact the housing of the bar portion 24 or can be configured to leave a length of the cables 84 extending out of the housing of the bar portion 24.

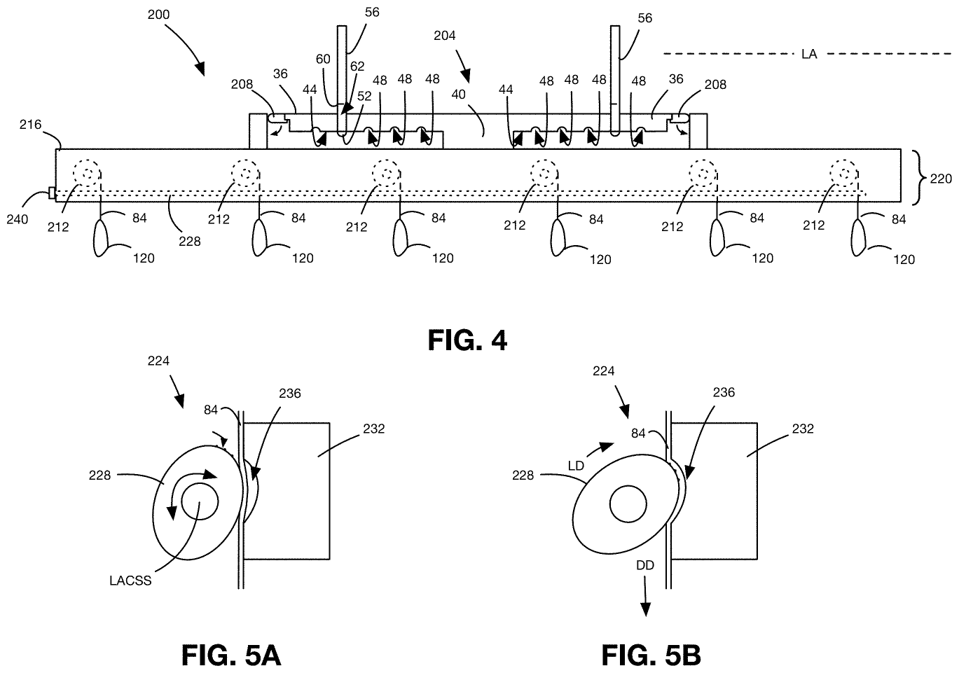

FIG. 4 shows a support bar 200 in accordance with another embodiment that is similar to the support bar 20 of FIGS. 1 to 3. Similar elements are numbered similarly and the above description of these elements applies. The support bar 200 has a hoist connector 204 that is similar to the hoist connector 32 of FIG. 1, but that employs spring-loaded gates 208 to restrict the release of the strap loops 56 from the hoist connector 204. The spring-loaded gates 208 can be pivoted downwards to facilitate the release of the strap loops 56 from the hoist connector 204. Six spring-loaded spools 212 are positioned within a housing 216 of a bar portion 220 of the support bar 200 and retract the cables 84 when not secured to a load.

FIG. 5A shows a clamping structure 224 for locking the cables 84 at a desired length. The clamping structure 224 includes an at least partially cam-shaped shaft 228 and a clamping block 232 having a recess 236 between which the cables 84 pass. In FIG. 5A, the clamping structure 224 is shown in an open state, wherein the cable 84 can pass relatively freely between the cam-shaped shaft 224 and the clamping block 232. The cam-shaped shaft 224 is rotatable via a lever 240 shown in FIG. 4 about its longitudinal axis LACSS between an open position shown in FIG. 5A and a locked position shown in FIG. 5B, wherein the cam-shaped shaft 224 is rotated to clamp the cable 84 in the recess 236 of the clamping block 232. Application of a force in a downward direction DD causes the cam-shaped shaft 224 to further rotate in a locking direction LD, wherein the cable 84 is further clamped as a result of the shape of the cam-shaped shaft 224.

The cam-shaped shaft 228 has an engagement surface that is textured or has features to provide more resistance to movement of the cable 84 once clamped.

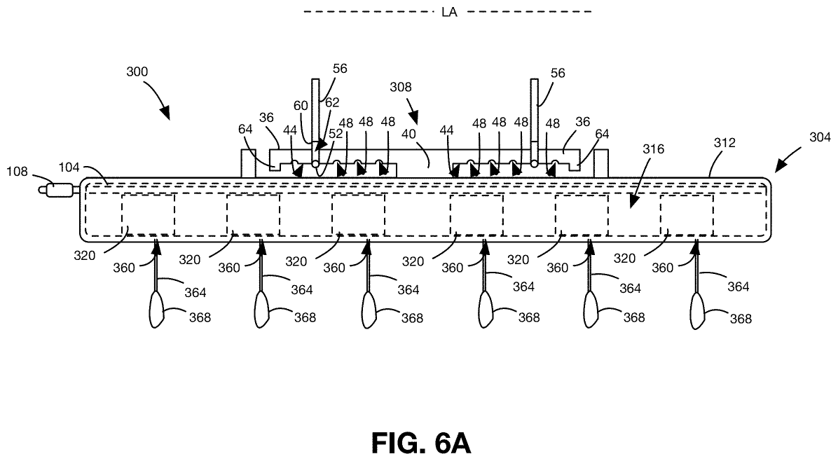

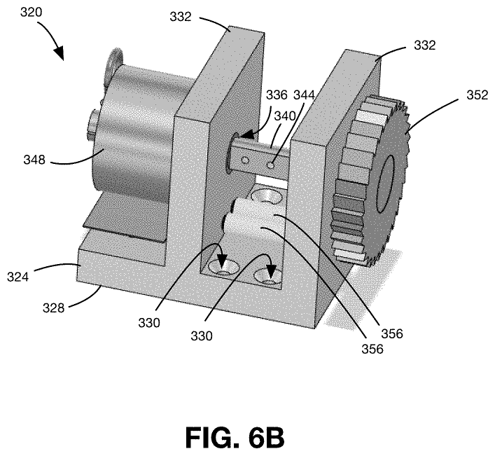

FIG. 6A shows a support bar 300 in accordance with another embodiment that is similar to the support bar 20 of FIGS. 1 to 4. Similar elements are numbered similarly and the above description of these elements applies. The support bar 300 includes a bar portion 304 that extends along a longitudinal axis LA. A hoist connector 308 extends from the bar portion 304 and is designed to enable connection to a hoist. As the elements of the hoist connector 308 are similar to those of the hoist connector 32 of FIG. 1, reference can be made to their descriptions with respect to FIG. 1. The bar portion 304 includes a generally tubular housing 312 that is constructed of steel, aluminum, or any other material that is sufficiently rigid and resistant to bending forces. The housing 312 has a cavity 316 in which are positioned six spool modules 320.

One of the spool modules 320 is shown in greater detail in FIG. 6B. The spool module 320 includes a spool module frame 324 including a base plate 328 having four fastener apertures 330 for receiving bolts to secure the base plate 328 to the housing 312. Two generally parallel wall plates 332 extend generally perpendicularly from the base plate 328. Each of the wall plates 332 has a central aperture 336 in which a spool shaft 340 is rotatably positioned. The spool shaft 340 includes one or more apertures 344 that are positioned between the wall plates 332 to which a cable can be secured. In the illustrated configuration, the spool shaft 340 has two apertures 344. One end of the spool shaft 340 is connected to a torsion spring 348 to apply a biasing torque biasing rotation of the spool shaft 340 towards a neutral angular position. A gear 352 is secured to the spool shaft 340 at the other end thereof. Two parallel guide rollers 356 are rotatably positioned between the wall plates 332 and are separated by a small gap enabling a cable to pass therebetween. The guide rollers 356 are positioned to align the gap between them generally centrally along the width of the spool module 320.

Now with reference to FIGS. 6A and 6B, the gap between the two guide rollers 356 is positioned over a slot in the base plate 328 that is aligned with a slot 360 centrally positioned along the width of the housing 312 to enable a cable 364 to pass therethrough. The cable 364 is secured to the spool shaft 340 via at least one of the apertures 344. When the spool shaft 340 is in the neutral angular position towards which it is biased by the torsion spring 348, the cable 364 extends a small distance out of the slot 360. A carabineer 368 is secured at the distal end of each cable 84 for securing the cable 84 to a load.

Each of the spool modules 320 is configured to enable extension of the cable 364 and be lockable. In particular, the spool modules 320 are lockable by rotation of the control lever 108 to rotate the pawl coupling bar 104, which causes a corresponding pawl 100 to engage the gear 352. Engagement of the gear 352 by the pawl 100 prevents rotation of the spool shaft 340 and thus further extension of the cable 364 from the bar portion 304. Locking of the spool module 320 inhibits further extension of the cable 364 from the spool module 320. Locking is achieved via the same structure as shown in FIGS. 2A to 2D, and the corresponding elements are numbered similarly in FIGS. 6A and 6B. By routing the cable 364 out through generally centrally positioned slot 360 along the width of the bar portion 304, and by positioning the hoist connector 308 generally centrally across the width of the bar portion 304, rotation of the support bar 300 during use can be mitigated. As will be appreciated, retraction of the cable 364 by the torque force of the torsion spring 348 is generally not inhibited by the pawl 100. Thus, when the cable 364 is no longer attached to a load, it will retract until the spool shaft 340 is rotated to a neutral angular position by the torsion spring 348.

In other embodiments, locking of the spool module 320 can also prevent retraction of the cable 364 back into the bar portion 304 via the torque force applied by the torsion spring 348, such as when the cable 364 is not under load. This can be achieved via a variety of structures, such as a toothed cog that is engaged to prevent rotation in either direction.

In scenarios where ligatures extend from a retention structure retaining a person at locations that are generally not aligned, such as along the lateral sides of the person, the aggregation of those connections to a single point or line can compress the person in the retention structure as the person's weight pulls the person downward. It can therefore be desirable to provide a support structure that can provide support along two dimensions in the horizontal plane; e.g., laterally and longitudinally where the person is positioned supine. This is particularly true for persons of larger dimensions, such as bariatric patients.

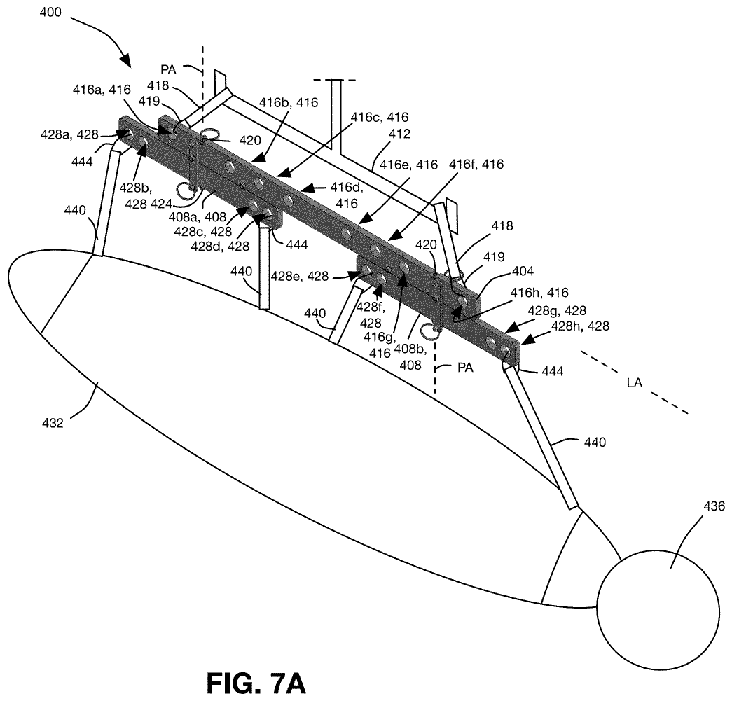

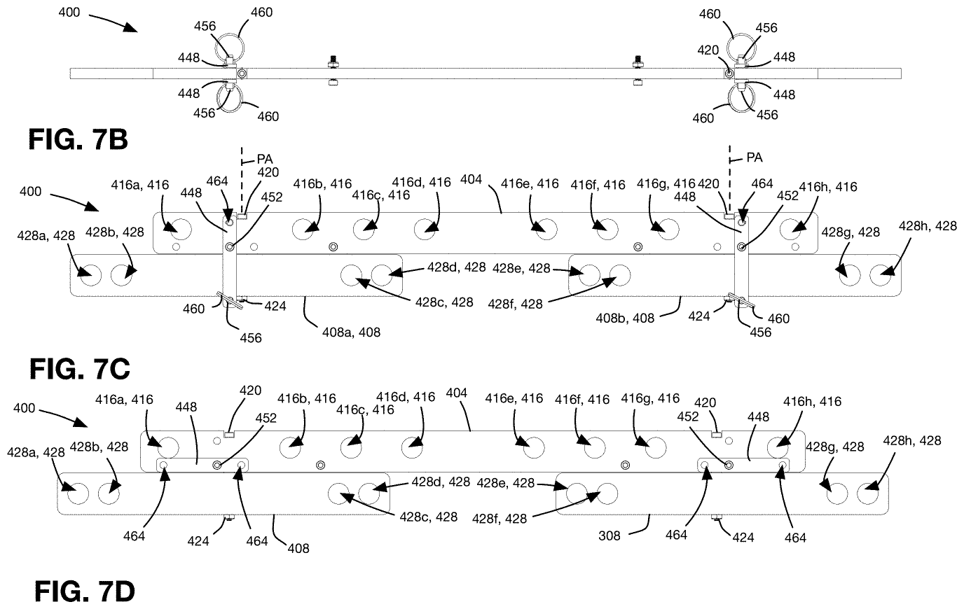

FIG. 7A shows a support structure 400 in accordance with another embodiment. The support structure is a reconfigurable support bar 400 that includes a main bar 404 and two auxiliary bars 408a, 408b (collectively alternatively referred to herein as auxiliary bars 408) that are pivotally connected to the main bar 404. The main bar 404 and auxiliary bars 408 can be made of any suitably rigid material that is resistant to bending forces, such as steel. The main bar 404 acts as a hoist connector configured to connect to a T-bar 412 of a hoist. In particular, a set of connector features in the form of hoist connector apertures 416a to 416h (alternatively collectively referred to herein as hoist connector apertures 416) extend through the main bar 404 along a range of positions, and facilitate coupling of the main bar 404 to the T-bar via a set connectors in the form of straps 418 with carabiners 419 at their ends. As will be appreciated, any other suitable connectors can be used to connect the main bar 404 to the T-bar. In other embodiments, the connector features can be rings, protrusions with channels, slots, etc.

The main bar 404 has a pair of through holes, and each of the auxiliary bars 408 has a corresponding through hole. A pivot pin 420 is inserted in each of the through holes of the main bar 404 and the through hole of a corresponding one of the auxiliary bars 408, and a nut 424 secures the pivot pin 420 therein. As a result, each of the auxiliary bars 408 can pivot about a pivot axis PA relative to the main bar 404.

Each of the auxiliary bars 408 have a set of connector features in the form of load connector apertures 428a to 428h (alternatively collectively referred to herein as load connector apertures 428) for securing connectors to connect to a retention structure for retaining a person. As illustrated, the retention structure in this embodiment is a wrap 432 that encircles a person 436. The wrap 432 can include or can have attached a set of connectors in the form of connector straps 440 that extend from the wrap 432. Each of the connector straps 440 has a carabineer 444 at its distal end for connecting the wrap 432 to the load connector apertures 428 of the auxiliary bars 408.

The reconfigurable support bar 400 is shown in FIG. 7A in a compact state. In the compact state, a longitudinal axis of each of the auxiliary bars 408 is parallel to a longitudinal axis LA of the main bar 404.

Now with reference to FIGS. 7A to 7C, a locking bar 448 is pivotally coupled via a pivot pin 452 to the main bar 404 on either side of each auxiliary bar 408. The pivot pin 452 is offset longitudinally from the pivot pin 420. A locking pin 456 having a pull ring 460 is inserted through each of a pair of through holes 464 in adjacent locking bars 448 and a corresponding through hole in the main bar 404. The locking pins 456 friction fit into the through holes 464 to lock the orientation of the locking bars 448 transverse the longitudinal axis LA of the main bar 404. In this position, the locking bars 448 prevent pivoting of the auxiliary bars 408 relative to the main bar 404 about their pivot axes PA.

The support structure 400 can be reconfigured in an extended state in which at least two of the set of connector apertures are further apart than in the compact state. This enables support of the person along a greater length or area so that the person retained in the retention structure (e.g., the wrap) can be less constricted as the connectors extending from the retention structure can extend more vertically and/or more outwardly towards the support bar 400.

In order to reconfigure the support bar 400 to the extended state, the locking pins 456 are withdrawn from the through holes 464 by pulling them out via the pull rings 460. Once the locking pins 456 are withdrawn, the locking bars 448 are pivoted about the pivot pins 452 to reorient the longitudinal axis of the locking bars 448 generally parallel to the longitudinal axis of the main bar 404. FIG. 7D shows the support bar 400 after pivoting of the locking bars 448.

With the locking bars 448 pivoted to their position shown in FIG. 7D, the auxiliary bars 408 can be pivoted about the pivot axes PA of the pivot pins 420 so that the auxiliary bars 408 are oriented perpendicularly relative to the main bar 404. The locking bars 448 can then be pivoted back to their original position to lock the auxiliary bars 408, thereby preventing them from pivoting about the pivot axes PA.

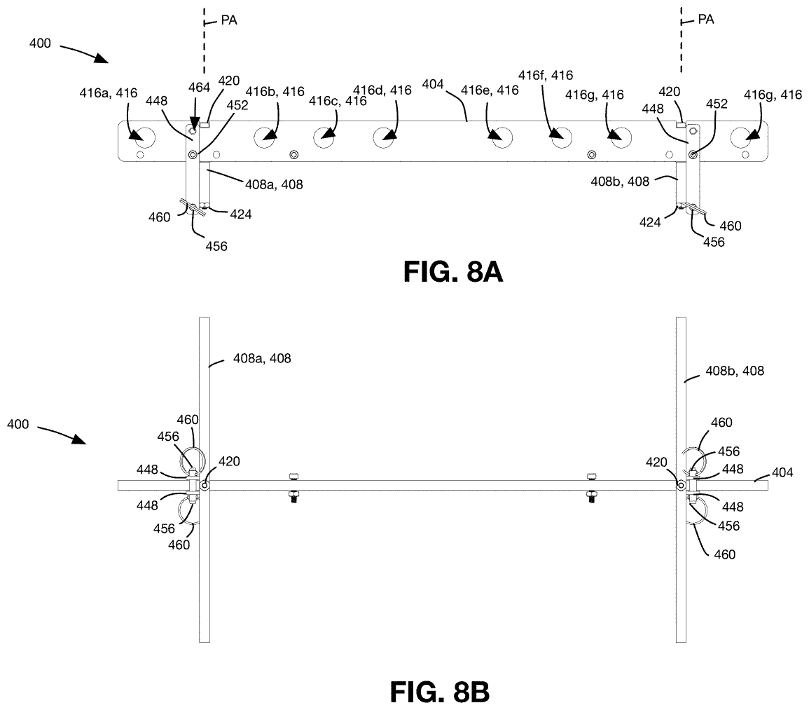

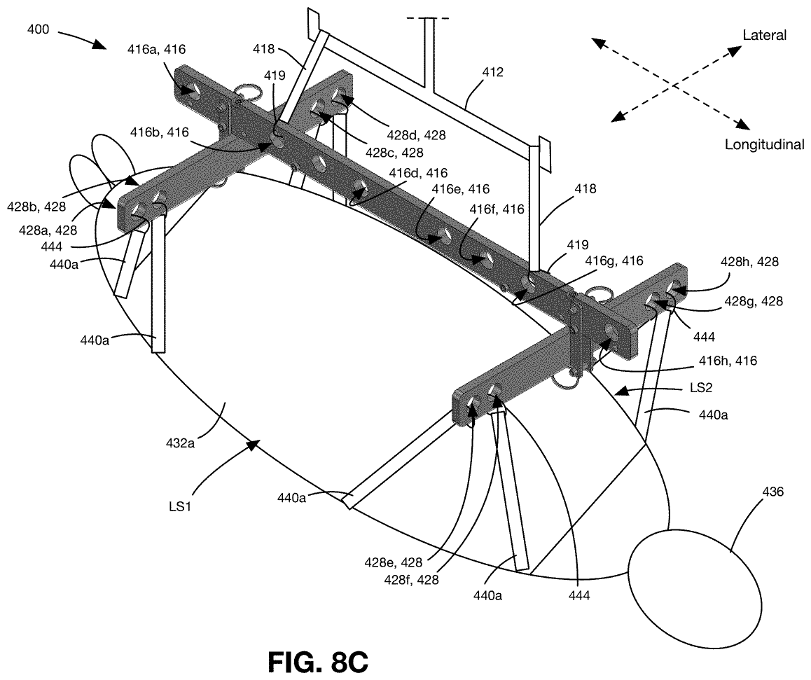

FIGS. 8A and 8B show the support bar 400 in the extended state, wherein the auxiliary bars 408 are locked in an orientation wherein their longitudinal axes extend perpendicular to the longitudinal axis LA of the main bar 404.

FIG. 8C shows the support bar 400 in the extended state in use, lifting a person 436. In the extended state, at least two of the set of load connector apertures 428 are further apart than in the compact state. In particular, for example, load connector aperture 428d is positioned further apart from load connector aperture 428e. By distancing at least some of the load connector apertures 428 further apart in the extended state, the person in the wrap 432a can be subject to less compression and resulting discomfort as the connector straps 440a can extend more outwardly as they extend upwardly towards the support bar 400. In the compact state, the load connector apertures 428 are generally aligned linearly. In the extended state, however, the load connector apertures 428 extend along two generally perpendicular axes. That is, the load connection apertures extend further along at least one axis in the extended state than in the compact state. In this manner, the support bar 400 can be extended to support a person retained in a retention structure along two axes in the horizontal plane and collapsed to facilitate storage.

The person is retained in a retention structure in the form of a wrap 432a that is similar to wrap 432 but differing in dimensions. The wrap 432a has attached a set of connectors in the form of connector straps 440a that extend from the wrap 432a. In particular, the wrap 432a has connector straps 440a that extend from each of the two lateral sides LS1, LS2 thereof. Each of the connector straps 440a has a carabineer 444 at its distal end for connecting the wrap 432 to the load connector apertures 428 of the auxiliary bars 408. The extended positions of the load connector apertures 428 as a result of the support bar 400 being in an extended state enables the wrap 432a and the person 436 held by it to be supported at positions so that the connector straps 440a extend more vertically. As a result, the person 436 is subjected to less compression by the wrap 432a elevated by the support bar 400 and T-bar.

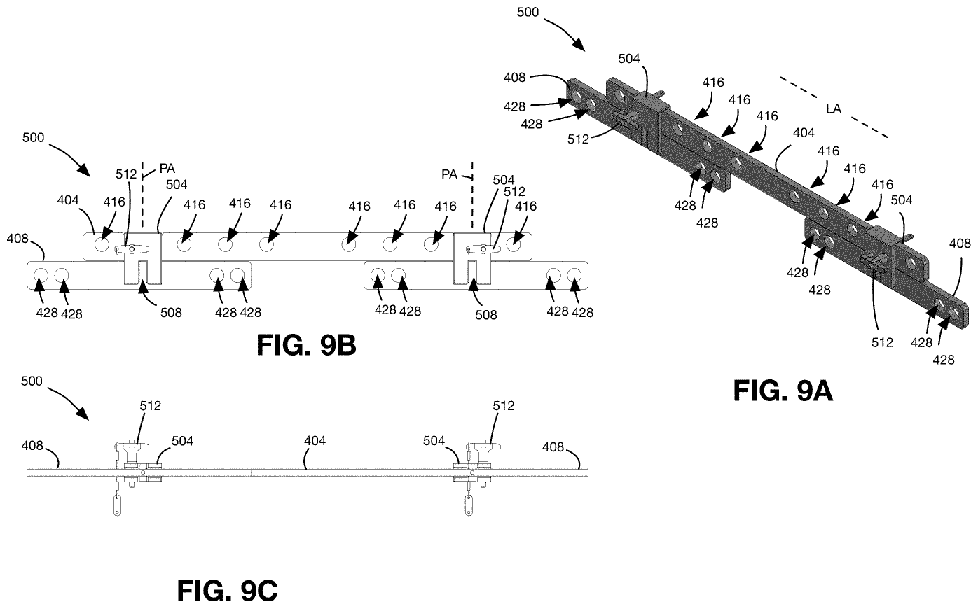

FIGS. 9A to 9C show a support structure in accordance with another embodiment. In particular, the support structure is a support bar 500 shown in a compact state. The support bar 500 is somewhat similar to the support bar 400 of FIGS. 7A to 8C. Like elements are numbered similarly and the above description applies for these elements. The auxiliary bars 408 pivot in the same manner relative to the main bar 404 as they do in the embodiment shown in FIGS. 7A to 8C. In this embodiment, a pair of notched U-shaped brackets 504 are secured to the main bar 404. Each U-shaped bracket 504 extends down over a corresponding one of the auxiliary bars 408 on both lateral sides of the main bar 404. A notch 508 extends upwardly at the bottom of each side of the U-shaped brackets. A securing bolt 512 having a handle is secured in through holes of each of the U-shaped brackets 504 and the main bar 404 to secure the U-shaped brackets 504 on the main bar 404 and over the auxiliary bars 408. As a result, the auxiliary bars 408 are not able to pivot relative to the main bar 404.

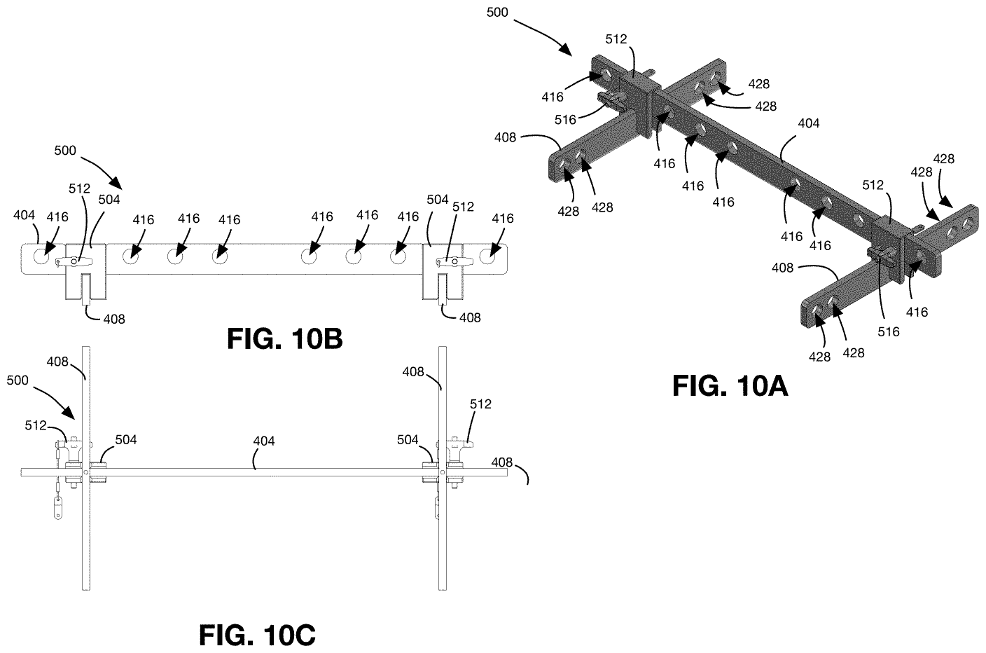

In order to reconfigure the support bar 500 from the compact state to an extended state, the securing bolts 512 are removed from the main bar 404 to enable the U-shaped brackets 504 to be slid away from the auxiliary bars 408. Once the auxiliary bars 408 are no longer covered by the U-shaped brackets 504, they can be pivoted about their pivot axes PA. When the longitudinal axes of the auxiliary bars 408 are perpendicular to the longitudinal axis LA of the main bar 404, the U-shaped brackets can be slid down so that the auxiliary bars 408 are received within the notches 508. The securing bolts are then re-secured to the U-shaped bracket 504 and the main bar 404 to fix the support bar 500 in the extended state, as shown in FIGS. 10A to 10C.

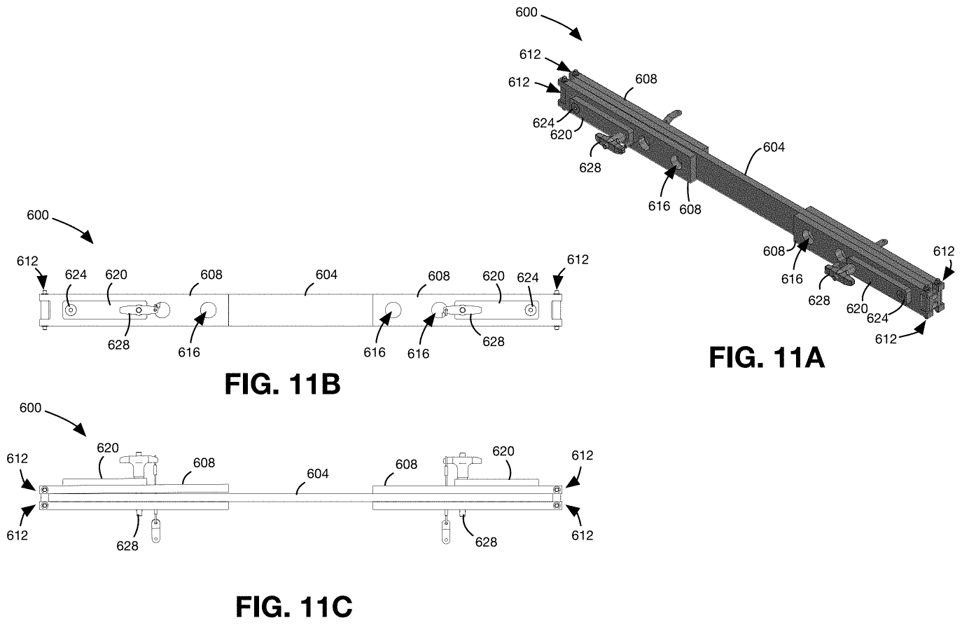

FIGS. 11A to 11C show a support structure in accordance with another embodiment. The support structure is a support bar 600. The support structure is a support bar 600 shown in a compact state. The support bar 600 includes a main bar 604 that is connected to a set of four auxiliary bars 608. Two auxiliary bars 608 are pivotally connected to each longitudinal end of the main bar 604 via hinges 612. In the compact state, the auxiliary bars 608 are folded against the lateral sides of the main bar 604. Each of the auxiliary bars 608 has two load connector apertures 616 positioned towards the distal end thereof. A locking bar 620 is pivotally coupled to each of two of the auxiliary bars 608 via a pivot pin 624. A securing bolt 628 having a handle is secured to the auxiliary bars 608 and the main bar 604 to secure the auxiliary bars 608 against the main bar 604 in the compact state.

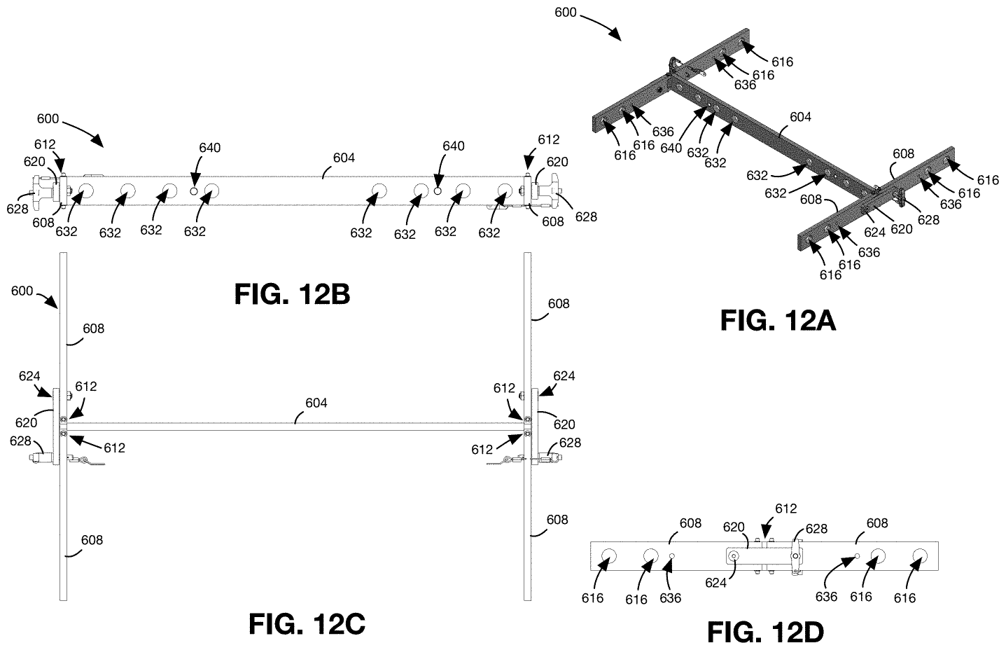

When it is desired to reconfigure the support bar 600 from the compact state to an extended state, the securing bolts 628 are withdrawn from main bar 404 to enable the auxiliary bars 608 to be pivoted about the hinges 612 until they extend perpendicularly from the main bar 604 and the two auxiliary bars 608 towards each end of the main bar 604 are aligned. The locking bars 620 can then be pivoted so that they extend across the adjacent auxiliary bars 608. The securing bolts 628 are then secured to the adjacent auxiliary bars 608 to secure the auxiliary bars in an extended state shown in FIGS. 12A to 12C. Also shown in these figures are the through holes 632, 636 in the main bar 604 and the auxiliary bars 608 through which the securing bolts 628 are positioned when the support bar 600 is in the compact state.

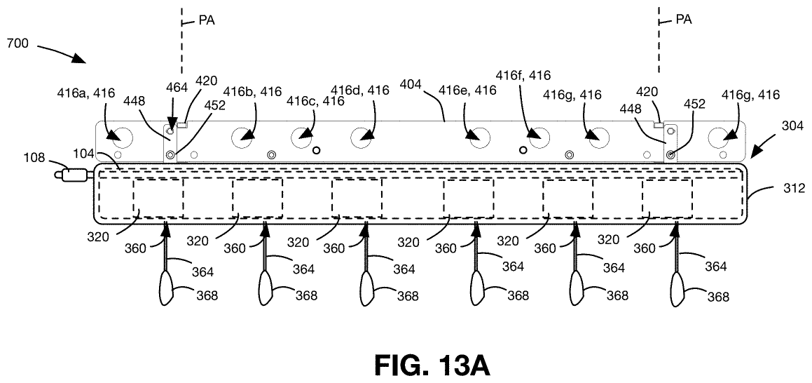

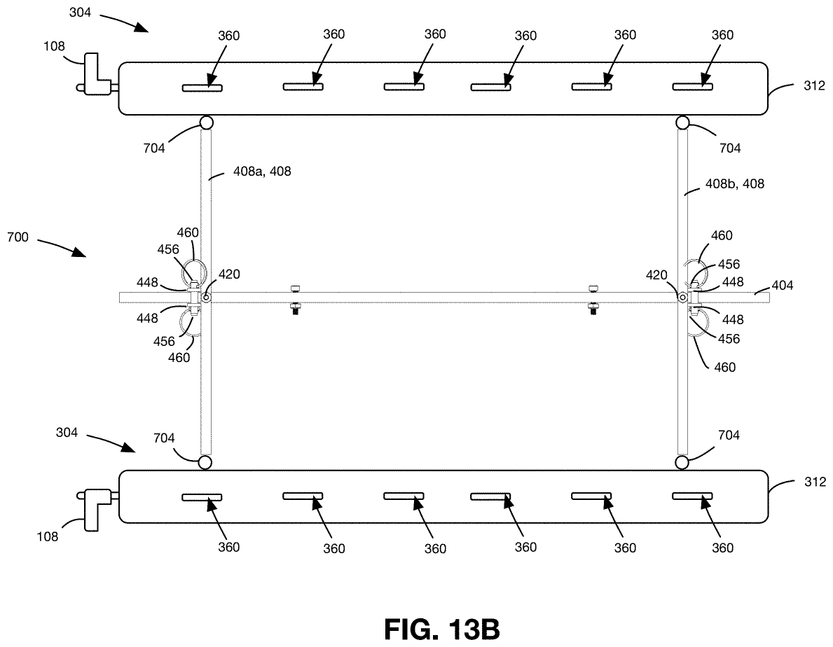

FIGS. 13A and 13B show a support structure 700 in accordance with yet another embodiment. In this embodiment, the support structure 700 includes a central frame resembling the support bar 400 of FIGS. 7A to 8B. Like elements are identified with the same reference numerals. In addition, each of a pair of bar portions 704 similar to the bar portion 304 of FIG. 6A is hingedly coupled to corresponding lateral ends of the pair of auxiliary bars 404 via hinges 704. The support structure 700 is illustrated in the extended state, and can be collapsed to a compact state much in the same manner as the support bar 400 of FIGS. 7A to 8B.

As will be appreciated, the load connector apertures 428 can be omitted as the independently extendable/retractable cables 364 can couple directly to a retention structure for a person.

The support structures can be extendible along one axis or along two axes. In some of the above embodiments, some support structures pivot. As a result, spacing between connector features can be reduced along one axis, but is extended along a second perpendicular axis. In other embodiments, the support structure can be telescoping to further space the connector features linearly. Other structures for facilitating the relative displacement of connector features are also contemplated.

While the hoists illustrated in the figures and described in the description are shown being connected to the support structures via a T-bar, other types of connections between the hoist and the support structures are contemplated. For example, the hoist may be connected to the support structures via a single cable or point of connection, or via two or more points of connection. Where a T-bar is illustrated or described, another type of hoist bar may also be used, e.g. an X-bar or an H-bar or a bar with any number of arms.

While, in the above-described embodiments, the support structures/bars have been rigid, other materials for the support structures can be selected that are generally inflexible to inhibit relative movement of the knees, hips, and shoulders of a person secured in a wrap or other retention structure and connected to the support structure at points along the span extending from at or below a person's knees to at or above their shoulders.

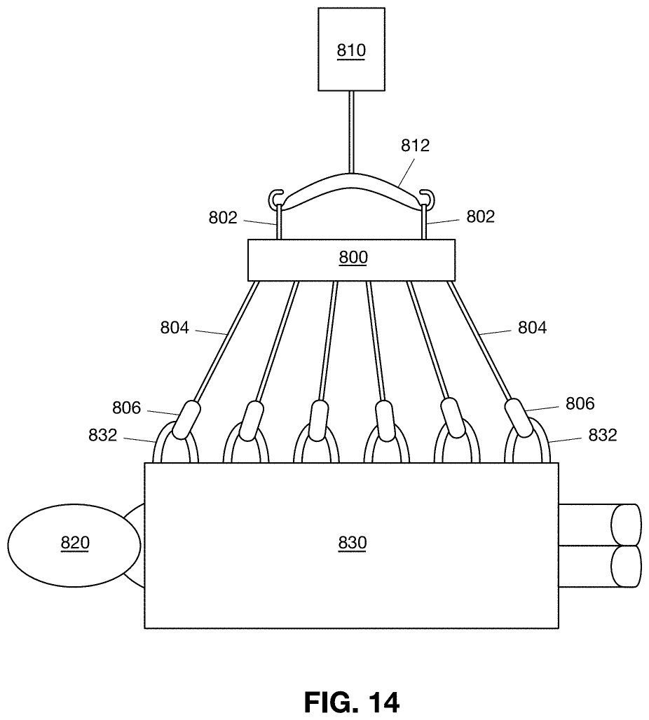

As previously described, it is advantageous to utilise a support bar to distribute the load of a person cocooned in a wrap and being lifted by a hoist. FIG. 14 is a side elevation view of a typical support structure configuration as previously described, with a person 820 cocooned in a wrap 830 and being lifted by a hoist 810. The wrap 830 has a set of connectors 832 along its length, and each connector 832 is connected to a support bar 800 via an adjustable-length support strap 804. Each strap 804 has a carabiner 806 or similar securing means at its end for coupling to connector 832. The support bar 800 is attached to a T-bar 812 of the hoist 810 via at least two hoist connector straps 802, or directly to a central hoist hook (not shown). It will be appreciated that any other means for connecting the support bar 800 to the hoist 810 can be employed. The support bar 800 may be any support bar as previously described, with apertures for connecting the straps 804, or with integral straps 804 that are adjustable in length and retractable via sprung or motorised spools. The straps 804, if attachable rather than integral to the support bar 800, may be adjustable in length, e.g. via buckles. The support bar 800 may incorporate any connection bar previously or subsequently described in this specification, both for connecting to the hoist 810 and to assist with leveling the supported person 820. The person 820 may be any person previously described in this specification, and the wrap 830 may be any wrap or other retention structure previously described in this specification.

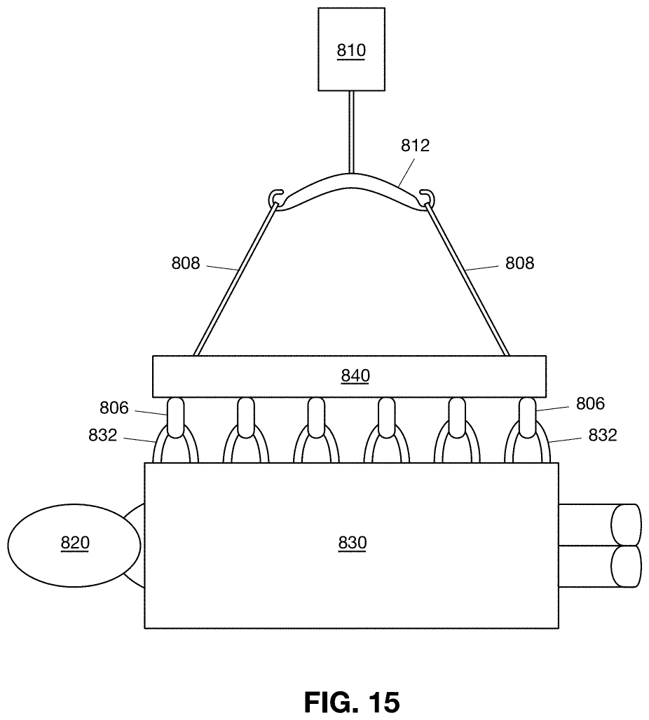

FIG. 15 is a side elevation view of a support structure configuration in accordance with another embodiment, with a support bar 840 closely coupled to the wrap 830. Carabiners 806 or similar, attached to the support bar 840, are coupled to the connectors 832 on the wrap 830. Velcro loops or similar, with a degree of adjustability, may be used in place of the carabiners 806 in order to closely couple the support bar 840 to a possibly variable contour of the cocooned person 820. The support bar 840 is connected to the hoist T-bar 812 (or central hoist hook, not shown) via adjustable-length hoist connector straps 808. The straps 808 may be adjustable in the same way as support straps 804, e.g. via extension from or retraction into the support bar 840 on a spool, via buckles, or any other suitable means. The end of each strap 808 may comprise a loop adapted for looping over the end of the T-bar 812 (or hoist hook).

In the support bar configuration of FIG. 15, the support bar 840 can be easily detached from the hoist 810 and placed beside the person 820 while remaining attached to the wrap 830. Thus, any risk associated with having a support bar suspended above the person 820 is eliminated. In the support bar configuration of FIG. 14, support bar 800 may be relatively shorter than the support bar 840.

In another alternative embodiment, the support bar 840 can be incorporated into the wrap 830, thereby obviating the need for the connectors 832 and the carabiners 806.

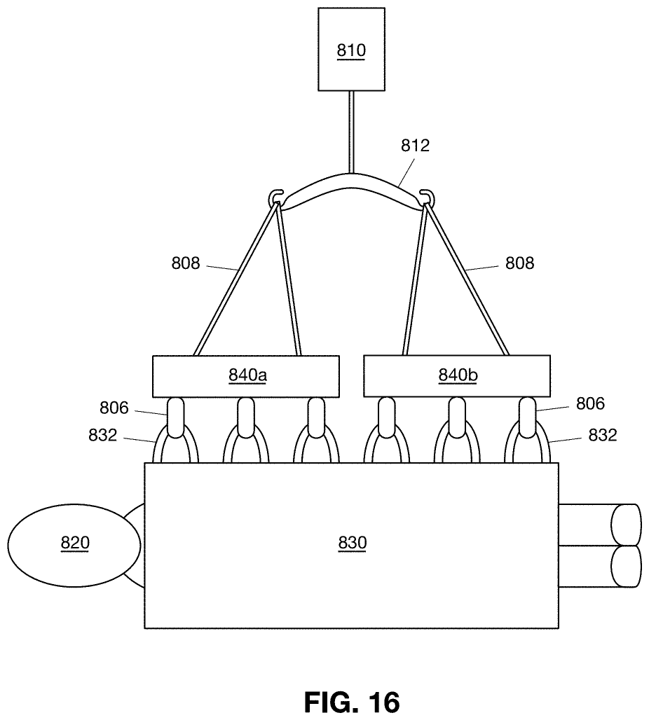

FIG. 16 is a side elevation view of a support structure configuration in accordance with another embodiment, with a pair of support bars 840a, 840b closely coupled to the wrap 830. The configuration of FIG. 16 is similar to the configuration of FIG. 15, but with a pair of support bars 840a and 840b in place of a single support bar 840, and therefore four hoist connection straps 808 in place of two. The use of two support bars 840a and 840b reduces the length of each support bar and therefore makes the support bars safer to handle.

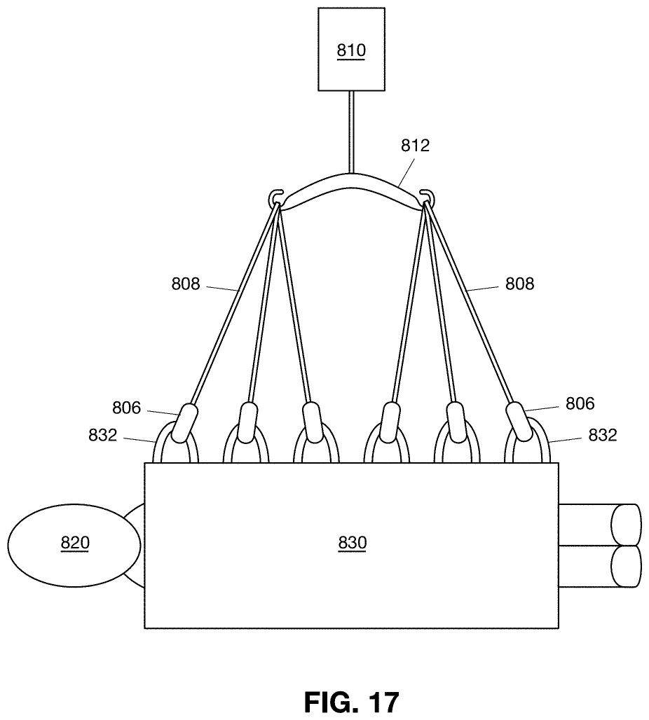

FIG. 17 is a side elevation view of a support strap configuration in accordance with another embodiment, with the wrap 830 coupled directly to the T-bar 812 (or hoist hook) via adjustable-length hoist connection straps 808, i.e. without an intervening support bar 800 or 840. The straps 808 may be adjustable via buckles or other similar means, or via retracting spools (not shown), as appropriate. This configuration has the advantage of simplicity, but relies on the wrap 830 to impart sufficient stiffness to the cocooned person 820 to reduce relative movement of the shoulders, hips, and knees of the person 820.

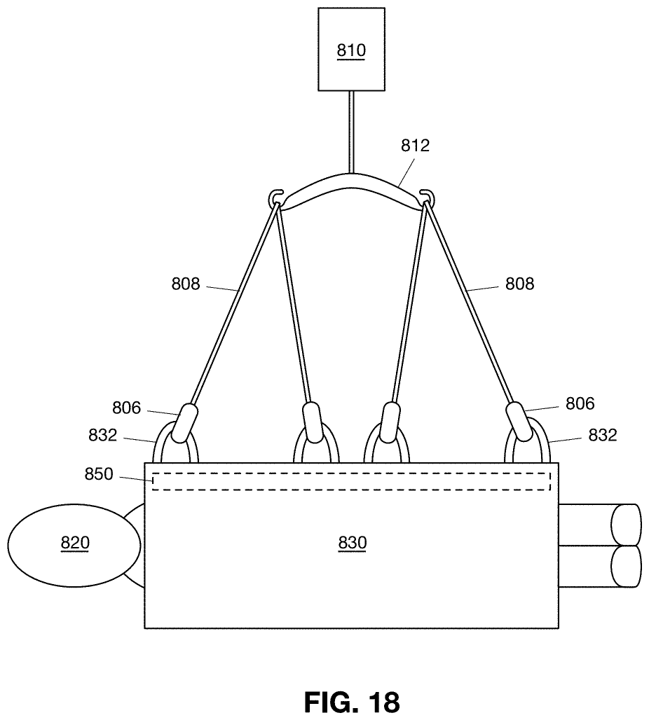

FIG. 18 is a side elevation view of a support strap configuration in accordance with another embodiment, again with the wrap 830 coupled directly to the T-bar 812 (or hoist hook) via adjustable-length hoist connection straps 808 per FIG. 17, but with a reduced number of straps 808 relative to the configuration of FIG. 17, and with the addition of a stiffener member 850 attached to or incorporated in the wrap 830.

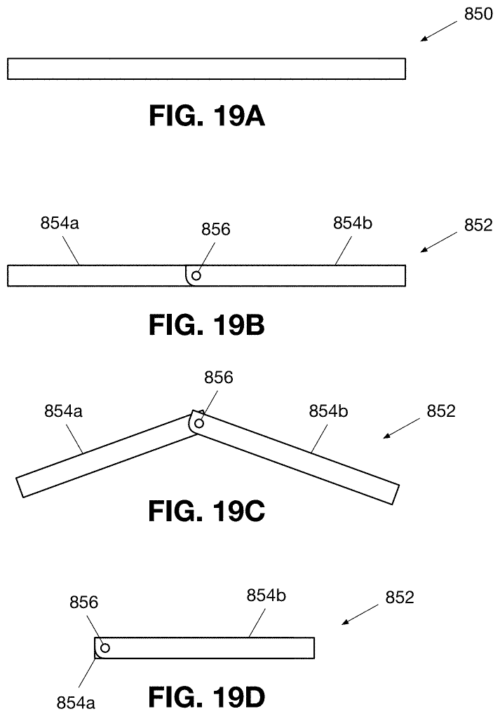

FIG. 19A is a side elevation view of the stiffener member 850. It may comprise a rigid or semi-rigid piece of any suitable material, e.g. a metal such as steel or aluminum, or a polymer, or carbon-fiber, or a carbon-fiber-infused polymer. The stiffener member 850 may be held in a sleeve of the wrap 830 and be removable from the wrap 830. Alternatively it may be permanently incorporated in the wrap 830. Alternatively still it may be attached to the exterior of the wrap 830. Still further, it can be provided by the wrap 830 via a thickening of the material, etc.

FIG. 19B is a side elevation view of a stiffener member 852 in accordance with another embodiment, comprising two segments 854a and 854b joined by a hinge 856, and adapted to fold at the hinge 856. Segment 854b may overlap segment 854a a distance beyond the hinge, to prevent the stiffener member 852 from folding upwards when the wrap 830 is suspended. The stiffener member 852 may comprise a pair of adjacent hinges 856 to allow it to fold while inside the wrap 830, i.e. as the wrap 830 itself is folded for e.g. storage. FIG. 19C is a side elevation view of the stiffener member 852 in a partially folded state, while FIG. 19D is a side elevation view of the stiffener member 852 in a fully folded state.

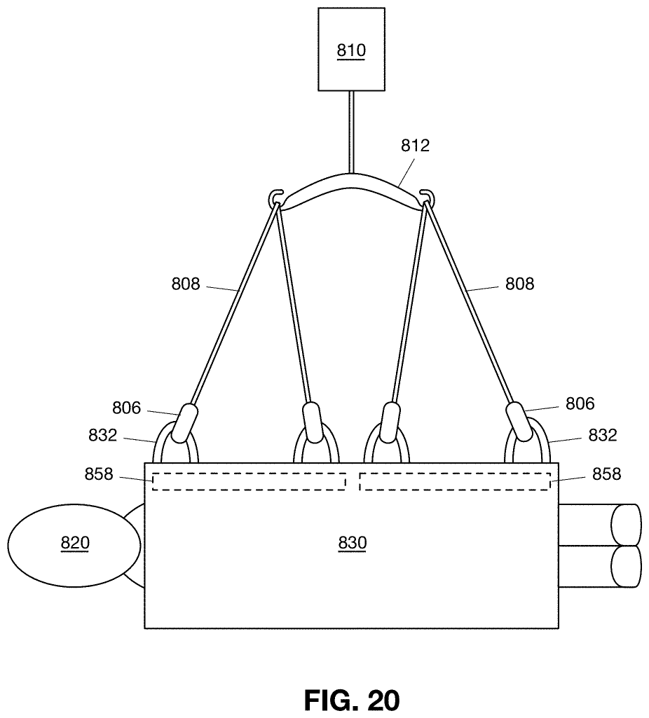

FIG. 20 is a side elevation view of a support structure configuration in accordance with another embodiment, again with the wrap 830 coupled directly to the T-bar 812 (or hoist hook) via adjustable-length hoist connection straps 808 per FIG. 18, but with a pair of short stiffener members 858 in place of the long stiffener member 850. This allows the wrap 830 to be folded in the middle e.g. for storage. Preferably, the stiffener members 858 extend longitudinally adjacent to the hips and knees to prevent flexure of the wrap thereat, with the break(s) between the stiffener member 858 occurring longitudinally along parts of the body of the person where flexion is less of an issue.

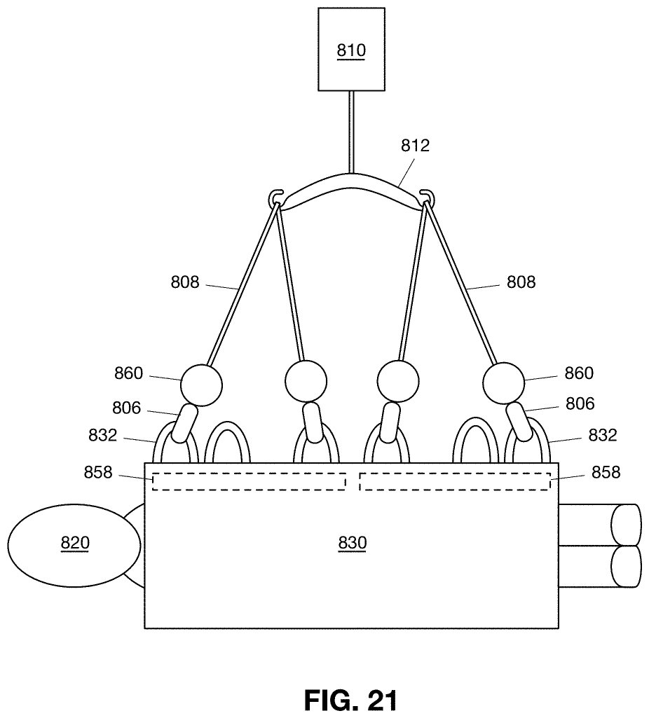

FIG. 21 is a side elevation view of a support structure configuration in accordance with another embodiment, again with the wrap 830 coupled directly to the T-bar 812 (or hoist hook) via adjustable-length hoist connection straps 808, and a pair of short stiffener members 830, per FIG. 20, but with each hoist connection strap 808 augmented with a retracting spool 860 to allow each strap 808 to be automatically retracted into the spool 860 when not in use. The spool 860 may be any suitable retracting spool with a locking mechanism to prevent further extraction or retraction, and may be of the same design as the retracting spools previously described in this specification.

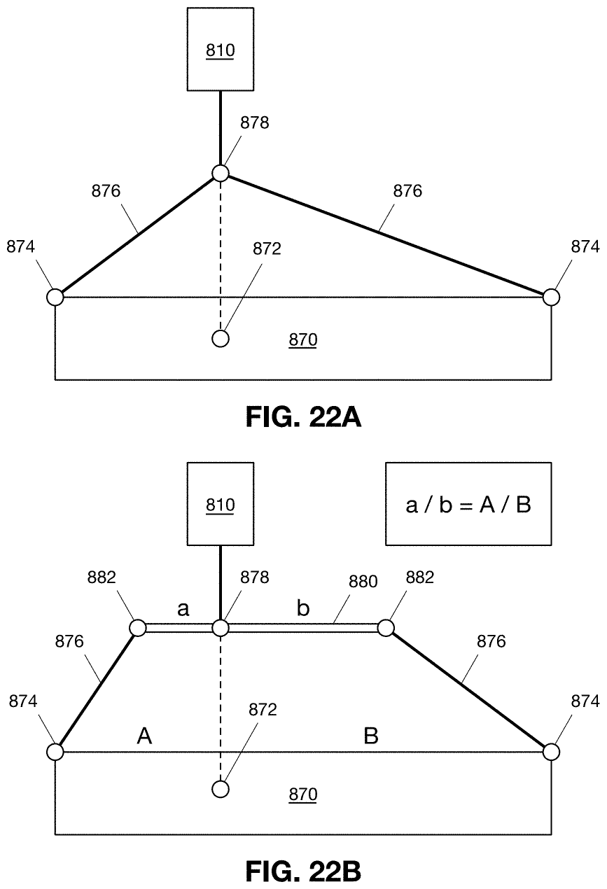

FIG. 22A is a side elevation view of a load-leveling configuration in accordance with another embodiment, with a load 870 directly connected to and being lifted by a hoist 810. The load has a left-of-center center of mass 872. Connection points 874 on the load 870 are connected via straps 876 to a central single lifting point 878 of the hoist 810 positioned longitudinally between the connection points 874. The lifting point 878 is aligned with the center of mass 872, and the straps 876 are taut. The straps 876 are advantageously adjustable in length to facilitate taut connection. This results in the load 870 being level, and illustrates the principle of aligning the lifting point 878 of the hoist 810 directly above the center of mass 872 of a load 870 to level the load 870.

The load 870 may be any load, including a person cocooned in a wrap 830 or held in another retention structure. When lifting a person using a hoist 810, it is advantageous to keep the person level both for their comfort and safety, and to facilitate whatever manipulation the lifting is in aid of, such as turning, proning, or transferring of the person, or providing personal care to the person.

FIG. 22B is a side elevation view of a load-leveling configuration in accordance with another embodiment, with the load 870 connected to the hoist 810 via an intermediate support element 880 and being lifted by the hoist 810. The load 870 has a left-of-center center of mass 872. Connection points 874 on the load 870 are connected via straps 876 to connection points 882 on the support element 880. A single central lifting point 878 is connected directly to the support element 880. The central lifting point 878 is aligned with the center of mass 872, the support element 880 is proportionally aligned with the center of mass 872, and the straps 876 are taut. The straps 876 are advantageously adjustable in length to facilitate taut connection. This results in the load 870 being level, and illustrates the principle of aligning the lifting point 878 of the hoist 810 directly above the center of mass 872 of a load 870, and aligning the support element 880 proportionally, to level the load 870.

If the mass of the support element 880 is negligible compared with the mass of the load 870, aligning the support element 880 proportionally results in a level load 870. If the mass of the support element 880 is more significant, then the alignment of the support element 880 can be adjusted accordingly.

In general, it is desirable to level the load 870 without the load 870 moving longitudinally (i.e., left-right in the Figures). This is achieved by positioning the lifting point 878 of the hoist 810 directly above the center of mass 872 of the load 870. If the hoist 810 is portable, then this may be achieved by moving the hoist 810 into the correct position, and/or adjusting the position of the lifting point 878 manually or under motor control once the hoist 810 has been positioned near the center of mass 872. If the hoist 810 is mounted on a track, e.g. on a ceiling above the load 870, then the hoist 810 and/or its lifting point 878 may be positioned over the center of mass 872 under motor control.

With no intermediate support element 880, per FIG. 22A, once the lifting point is positioned above the center of mass 872 and the straps 876 are taut, a level load 870 is achieved.

With an intermediate support element 880, per FIG. 22B, the support element 880 also needs to be properly aligned to achieve a level load 870. The support element 880 may comprise any support bar previously or subsequently described in this specification, including support bar 800. It may also comprise a T-bar 812 attached to the hoist 810. Additionally, it may comprise a combination of the T-bar 812 and support bar 800 (etc.), behaving largely as one for the purpose of leveling.

Since a T-bar 812 in isolation is generally connected to the hoist 810 with a fixed alignment, it does not generally facilitate having its alignment varied. Assuming the lifting point 878, i.e. coinciding with the center of the T-bar 812, is aligned with the center of mass 872, the load 870 will tilt when lifted, but will not move longitudinally. However, since the load 870 is balanced about its center of mass 872, it can be manually leveled without too much effort, e.g. during general manipulation of the load 870 once lifted.

When the support element 880 comprises a combination of the T-bar 812 and support bar 800 (etc.), the combination can be aligned by aligning the support bar 800 relative to the T-bar 812.

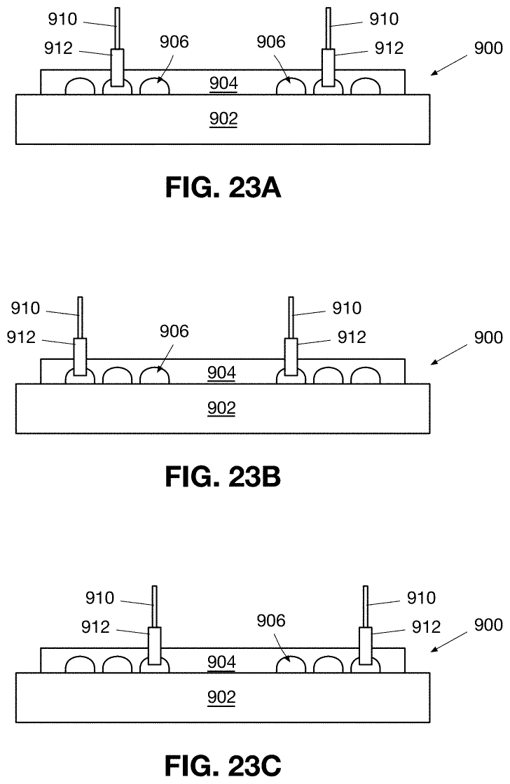

FIG. 23A is a side elevation view of a support structure in the form of a support bar 900 in accordance with another embodiment, comprising a support bar body 902 and a hoist connector 904 with multiple hoist connection apertures 906. The support bar body 902 may comprise any support bar or support bar portion previously described in this specification, and may comprise apertures for connecting support straps for connecting to a load, or may comprise auto-retracting support strap spools. A pair of hoist connection straps 910 are connected symmetrically, via a pair of carabiners 912, to a pair of the apertures 906. When symmetrically connected in this way, the support bar 900 is centrally aligned to the lifting point of the hoist, i.e. to support a load with a central center of mass.

FIG. 23B is a side elevation view of the support bar 900 with the straps 910 coupled to the support bar 900 for a load 870 with a left-of-center center of mass, and FIG. 23C is a side elevation view of the support bar 900 with the straps 910 coupled to the support bar 900 for a load with a right-of-center center of mass.

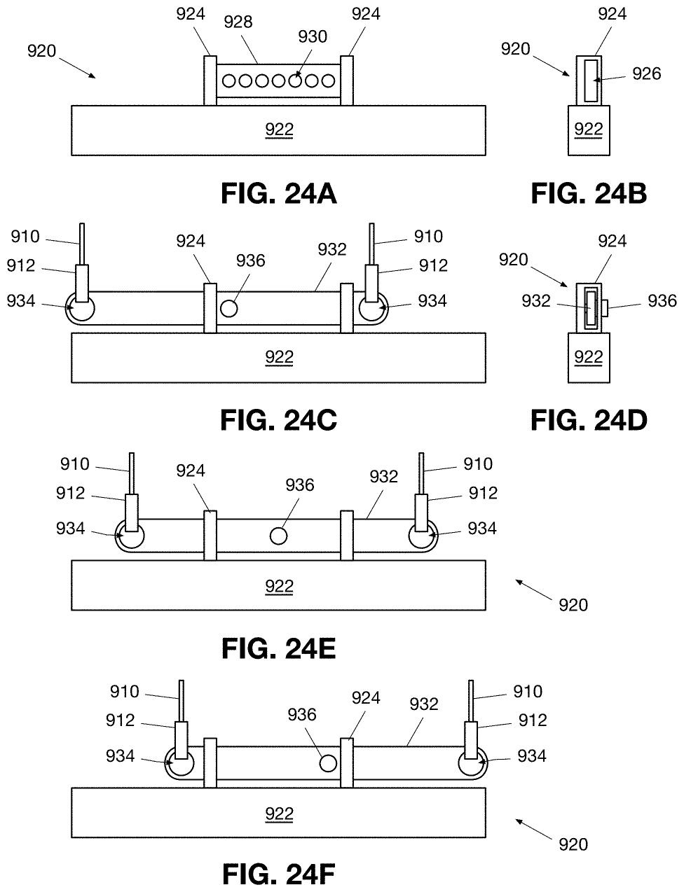

FIG. 24A is a side elevation view of a support structure in the form of a support bar 920 in accordance with another embodiment, comprising a support bar body 922 and a support structure for a movable hoist connector. The support structure comprises a pair of guide posts 924 and a locking plate 928 with a set of locking apertures 930. The support bar body 922 may comprise any support bar or support bar portion previously described in this specification, and may comprise apertures for connecting support straps for connecting to a load, or may comprise auto-retracting support strap spools. FIG. 24B is an end elevation view of the support bar 920. Each guide post 924 has a slot 926 for guiding the movable hoist connector.

FIG. 24C shows the support bar 920 with a hoist connector 932 held in place by the guide posts 924. The hoist connector 932 comprises a locking pin 936 adapted to engage with one of the locking apertures 930 of the locking plate 928 to configure an alignment of the hoist connector 932 with the support bar body 922. The hoist connector 932 also comprises a pair of hoist connection apertures 934, to which a pair of hoist connection straps 910 are attached via carabiners 912. The hoist connector 932 is shown in a leftmost position, i.e. configured for a load 870 with a left-of-center center of mass 872. FIG. 24D is an end elevation view corresponding to FIG. 24C. Hoist connector 932 is held and guided by slot(s) 926 of guide post(s) 924, and locked in place by locking pin 936.

FIG. 24E is a side elevation view of the support bar of FIG. 24C with the host connection bar 932 configured to support a load with a central center of mass, and FIG. 24F is a side elevation view of the support bar of FIG. 24C with the host connection bar 932 configured to support a load with a right-of-center center of mass.

Leveling a load before it is lifted by a hoist may involve a trial and error process before proper alignment, and hence leveling, is achieved. It is therefore advantageous to utilise a leveling mechanism that can be used to level a load once it has been partially or fully lifted. This has the advantage that leveling may be achieved more quickly, but has the disadvantage that the load will generally move longitudinally, assuming the hoist is stationary during the leveling process.

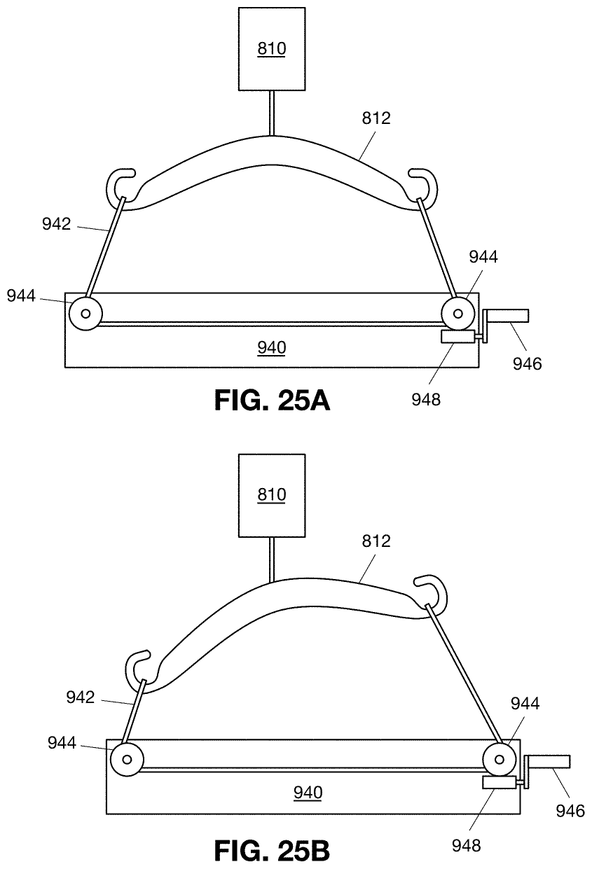

FIG. 25A is a side elevation view of a leveling mechanism in accordance with another embodiment, incorporated in a support structure in the form of a support bar 940. The support bar 940 may comprise any support bar or support bar portion previously described in this specification, and may comprise apertures for connecting support straps or may comprise auto-retracting support strap spools. The support bar 940 may, for example, comprise support bar 800 closely coupled to the hoist 810, or support bar 840 closely coupled to a wrap 830.

The leveling mechanism comprises a cable 942 that is connected to both ends of the T-bar 812, and passes through the support bar 940. The support bar 940 is suspended on the cable 942 by a pair of pulleys 944. One of the pulleys 944 is coupled to a handle 946 via a transfer gear 948.

The handle 946 may be cranked by hand to turn the coupled gear 948 and hence the coupled pulley 944, thereby transporting the cable 942, resulting in shortening of the distance between one end of the T-bar 812 and the support bar 940, and lengthening of the distance between the other end of the T-bar 812 and the support bar 940. This shifts the center of mass of a load supported by the support bar 940, and once it is aligned with the lifting point of the hoist 810 the load will be level. The pulley 944 coupled to the gear 948 grips the cable 942 with sufficient friction to prevent it from slipping when the pulley 944 is stationary. The gear 948 may be a worm gear, designed to drive a toothed rim of the pulley 944. As an alternative to coupling the gear 948 to the pulley 944, it may instead be coupled to a toothed block fixedly mounted to the center of the cable 942. The handle 946 may comprise a locking mechanism, not shown, to prevent accidental movement of the cable 942. The handle may alternatively be coupled directly to an axle of the pulley 944, i.e. without an intervening gear.

FIG. 25B is a side elevation view of the leveling mechanism of FIG. 25A, configured to support a load with a left-of-center center of mass. The T-bar 812 naturally tilts in order to achieve a stable configuration.

In an alternative embodiment, rotational friction of one or both pulleys and friction between the cable and the pulleys can be sufficient to enable the cable to be moved, such as manually, under a threshold force but not move otherwise. In this manner, the handle may be omitted.

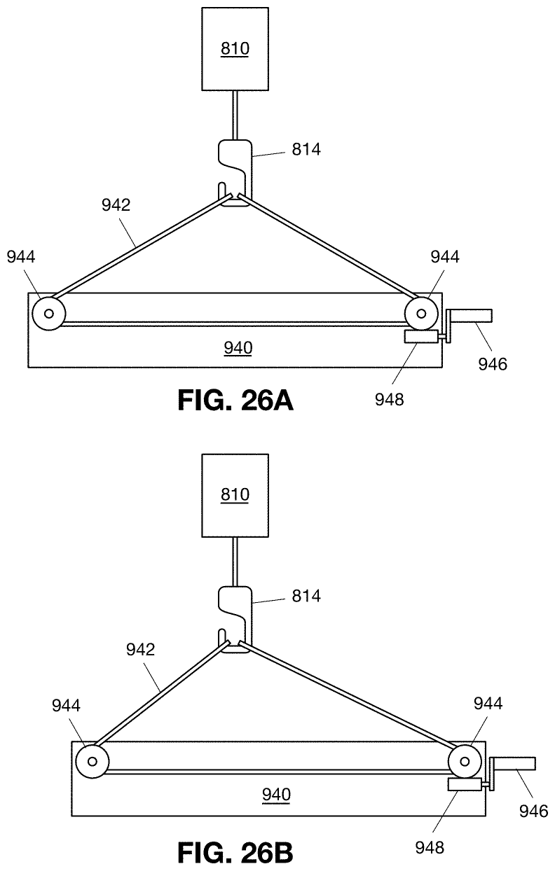

FIG. 26A is a side elevation view of a leveling mechanism of FIG. 25A attached to a central hoist hook 814 rather than the T-bar 812, resulting in a simpler configuration requiring less headroom, and less movement of the cable 942 to achieve alignment. FIG. 26B is a side elevation view of the leveling mechanism of FIG. 26A, configured to support a load with a left-of-center center of mass.

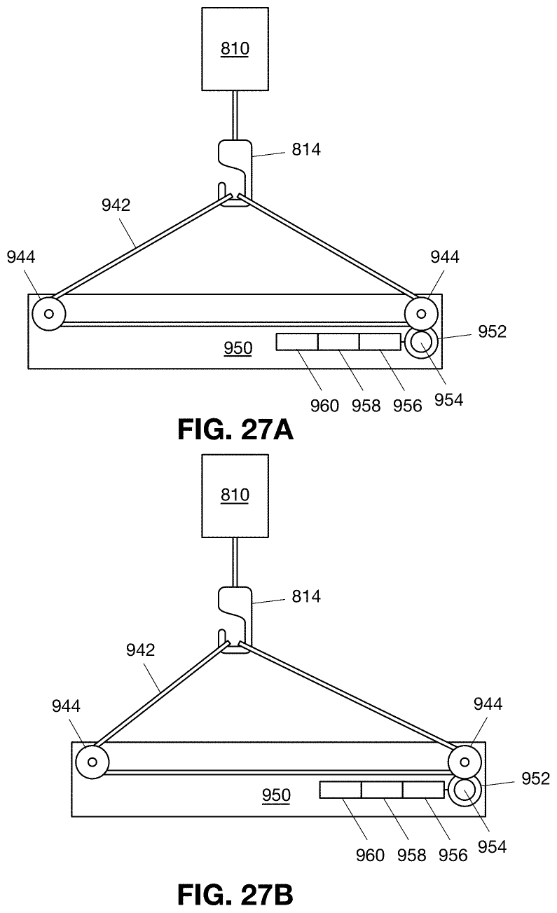

FIG. 27A is a side elevation view of a leveling mechanism in accordance with another embodiment, incorporated in a support bar 950. The support bar 950 may comprise any support bar or support bar portion previously described in this specification, and may comprise apertures for connecting support straps or may comprise auto-retracting support strap spools. The support bar 950 may, for example, comprise support bar 800 closely coupled to the hoist 810, or support bar 840 closely coupled to a wrap 830.

As described in relation to FIG. 26A, the leveling mechanism comprises a cable 942 that is connected at both ends to the hoist hook 814, and passes through the support bar 950. The support bar 950 is suspended on the cable 942 by a pair of pulleys 944. One of the pulleys 944 is coupled to a motor 952 via a transfer gear or roller 954. The gear 954 may be coupled to the pulley 944 via interlocking teeth or friction or the pulley 944 can be directly connected to the motor 952. The motor 952 may be controlled by an optional controller 956, and an optional level sensor 958 may provide the controller 956 with a level signal to allow it to automatically level the support bar 950, and hence the load, via the motor 952. The level sensor 958 may be any suitable level sensor, including an accelerometer and a mercury switch. The motor 952 and controller 956 are optionally powered by a battery 960, or alternatively by an external power source, e.g. provided via the hoist 810. The motor 952 and/or the controller 956 may be remotely controlled by wire or wirelessly, and the controller 956 optionally includes a wireless transceiver to facilitate wireless remote control (e.g. from a smartphone or similar device).

FIG. 27B is a side elevation view of the leveling mechanism of FIG. 27A, configured to support a load with a left-of-center center of mass.

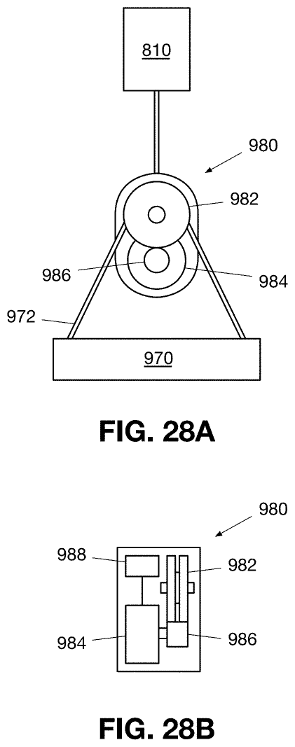

FIG. 28A is a side elevation view of a leveling mechanism 980 in accordance with another embodiment, comprising a cable 972 connected at both ends to a support bar (or load) 970. The support bar 970, if a support bar, may comprise any support bar or support bar portion previously described in this specification, and may comprise apertures for connecting support straps or may comprise auto-retracting support strap spools. The support bar 970 may, for example, comprise support bar 800 closely coupled to the hoist 810, or support bar 840 closely coupled to a wrap 830. The load 970, if a load, may be any load, including load 870.

The leveling mechanism 980 further comprises a leveling drive pulley 982 that supports and drives the cable 972. The drive pulley 982 is coupled to a motor 984 via a transfer gear or roller 986. The gear 986 may be coupled to the drive pulley 982 via interlocking teeth or friction.

FIG. 28B is an end elevation view of the leveling mechanism 980. The motor 984 may be controlled by an optional controller 988. An optional external level sensor (not shown) may provide the controller 988 with a level signal to allow it to automatically level the support bar (or load) 970 via the motor 984. The level sensor may be mounted on the support bar (or load) 970, and communicate by wire or wirelessly with the controller 988. The level sensor may be any suitable level sensor, including an accelerometer and a mercury switch. The motor 984 and controller 988 are optionally powered by a battery (not shown), or alternatively by an external power source, e.g. provided via the hoist 810. The motor 984 and/or the controller 988 may be remotely controlled by wire or wirelessly, and the controller 988 optionally includes a wireless transceiver to facilitate wireless remote control (e.g. from a smartphone or similar device).

To prevent longitudinal movement of the load during dynamic leveling, e.g. using any of the mechanisms described in relation to FIGS. 25A through 28B, the position of the hoist 810 may be adjusted simultaneously (or sequentially) to align the lifting point with the center of mass of the load. If the hoist 810 is motorised and the leveling mechanism is motorised, e.g. as described in relation to FIGS. 27A through 28B, then they can be synchronised so that leveling is achieved with no longitudinal movement of the load 870, i.e. the motion of the hoist 810 towards the center of mass 872 exactly matches the progress of the leveling operation.

While straps are employed to couple the support structure to the hoist and/or the load, other types of connectors such as cables, etc. can be employed.

In other embodiments, the support structures described with reference to the embodiments above can also be used to lift other types of loads, such as other animals and objects.

Persons skilled in the art will appreciate that there are yet more alternative implementations and modifications possible, and that the above examples are only illustrations of one or more implementations. The scope, therefore, is only to be limited by the claims appended hereto and any amendments made thereto.

What is claimed is:

1. A support structure for at least partially elevating a person via a hoist, the support structure being connectable to or forming part of a retention structure secured around a person, comprising:
at least two connectors configured for connecting to the hoist, the at least two connectors being located or locatable to enable selection of a first set of positions or a second set of positions at which the hoist is connectable to the support structure, each of the first set of positions and the second set of positions extending along a span of a longitudinal axis of the retention structure, the span of the second set of positions differing from the span of the first set of positions.

2. The support structure of claim 1, wherein the retention structure is a wrap.

3. The support structure of claim 2, wherein the support structure forms part of retention structure.

4. The support structure of claim 2, wherein each of the at least two connectors is an aperture.

5. The support structure of claim 1, wherein the support structure includes a support member to which the retention structure is connectable.

6. The support structure of claim 5, wherein each of the at least two connectors is a notch along a surface of the support member that at least partially faces downwards when the support structure is connected to the retention structure and the hoist.

7. The support structure of claim 5, wherein the at least two connectors are apertures.

8. The support structure of claim 7, wherein one or more of the at least two connectors is located on at least one connector support member that is secured to the support member and movable relative to the support member.

9. The support structure of claim 8, wherein the at least one connector support member slidingly engages the support member.

10. The support structure of claim 9, wherein the at least one connector support member is fixable at discrete locations relative to the support member.

11. The support structure of claim 10, wherein the at least two connectors comprises at least three connectors, wherein the at least three connectors are located at fixed locations along the support structure, and wherein each set of the first set of positions and the second set of positions corresponds to a subset of the at least three connectors.

12. A method of at least partially elevating a person via a hoist, comprising:
connecting a support structure to a retention structure secured around a person, the support structure including a support member to which the retention structure is connectable, the support structure including at least two connectors configured for connecting to the hoist, the at least two connectors being located or locatable to enable selection of a first set of positions or a second set of positions at which the hoist is connectable to the support structure, each of the first set of positions and the second set of positions extending along a span of a longitudinal axis of the retention structure, the span of the second set of positions differing from the span of the first set of positions;
connecting the hoist to at least a subset of the at least two connectors of the support structure; and
operating the hoist to elevate the support structure and at least partially elevate the retention structure secured around the person.

13. The method of claim 12, wherein each of the at least two connectors is a notch along a surface of the support member that at least partially faces downwards when the support structure is connected to the retention structure and the hoist.

14. The method of claim 12, wherein the at least two connectors are apertures.

15. The method of claim 14, wherein one or more of the at least two connectors is located on at least one connector support member that is secured to the support member and movable relative to the support member, the method further comprising moving the connector support member relative to the support member to select the first set of positions or the second set of positions.

16. The method of claim 15, wherein the at least one connector support member slidingly engages the support member.

17. The method of claim 15, wherein the at least one connector support member is fixable at discrete locations relative to the support member.

18. The method of claim 12, wherein the at least two connectors comprises at least three connectors, wherein the at least three connectors are located at fixed locations along the support structure, wherein the first set of positions corresponds to a first subset of the at least three connectors, and wherein the second set of positions corresponds to a second subset of the at least three connectors, the method further comprising connecting the hoist to one of the first subset of the at least three connectors and the second subset of the at least three connectors.

19. The method of claim 18, wherein each of the at least three connectors is an aperture.

20. The method of claim 19, wherein the support structure forms part of retention structure.
